(19) United States
(12) Patent Application Publication
(10) Pub. No.: US 2008/0154683 A1
(43) Pub. Date: Jun. 26, 2008

(54) COMPUTER SYSTEM FOR A COMMODITIES DELIVERY SYSTEM

(76) Inventors: Yohei Kawada, Yokohama (JP); Yoshihiro Mizuno, Yokohama (JP); Yusuke Matsui, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/947,989

(22) Filed: Nov. 30, 2007

(30) Foreign Application Priority Data
Nov. 30, 2006 (JP) 2006-323811

(51) Int. Cl. G06Q 10/00; G06Q 99/00

(52) U.S. Cl. 705/8; 705/1; 705/7

(57) ABSTRACT

This invention provides a computer system capable of jointly delivering commodities not included in delivery plan information even after the delivery plan information is generated, and each base receives the generated delivery plan information, or a transport unit has made the round of each base. The computer system for realizing a delivery system which controls the transport unit to make the round of bases, thereby delivering commodities to the bases, includes a shipping base terminal, a reception base terminal, a transport terminal, and an information management computer, and the information management computer refers to attribute information of the commodities requested to be delivered to select commodities to replace with the commodities requested to be delivered from the commodities planned to be delivered, and corrects the delivery plan information.

### CLAIM OF PRIORITY

The present application claims priority from Japanese patent application JP 2006-323811 filed on Nov. 30, 2007, the content of which is hereby incorporated by reference into this application.

### BACKGROUND OF THE INVENTION

This invention relates to a computer system for realizing a delivery system through which transport means makes the round of bases to delivery commodities to the bases, and more particularly, to a computer system for correcting delivery plan information in which a plan for the transport means to deliver commodities to the bases is registered.

There has recently been an increase in demands for reducing transport costs and environmental loads in the distribution industry. From the standpoints of reducing transport means and enhancing load efficiency, a joint delivery system which enables a plurality of companies to jointly transport commodities has been attracting attention.

For example, according to a joint delivery system called milk run, without setting up any delivery bases to be jointly used by a plurality of companies, transport means makes the round of a shipping base and a receiving base to deliver commodities. Thus, transport means can be reduced, and load efficiency of the transport means can be enhanced.

### SUMMARY OF THE INVENTION

As an information management system for realizing such joint delivery, for example, a technology described in JP 2005-75634 A is known. The technology described in JP 2005-75634 A enables each shipping base to understand contents to be shipped beforehand by receiving pieces of shipping schedule information en bloc from a plurality of shipping bases at an order receiving center, and simultaneously delivering shipping instruction information to all the bases from the order receiving center, thereby realizing efficient delivery.

According to the technology described in JP 2005-75634 A, based on the pieces of shipping schedule information transmitted from the shipping bases, the order receiving center generates delivery plan information so that load efficiency of transport means such as a truck can approach 100%. Then, the transport means transports commodities according to the delivery plan information.

Accordingly, in the case of delivering commodities suddenly required to be delivered through joint delivery, after the transmission of the delivery plan information to each base, even upon reception of shipping schedule information not contained in the delivery plan information, the order receiving center cannot deal with the received shipping schedule information. Thus, commodities of this shipping schedule registered information are individually delivered directly, so transport costs inevitably increase. The commodities suddenly required to be delivered are, for example, commodities to be replaced with commodities, which have been sold to a consumer, including defects.

A first object of this invention is to provide a computer system capable of jointly delivering commodities not contained in delivery plan information even after the delivery plan information is generated, and each base receives the generated delivery plan information, or transport means has made the round of each base.

In joint delivery, load efficiency of transport means is about 100% in many cases, and commodities not contained in the delivery plan information cannot be loaded on the transport means in many cases.

Thus, a second object of this invention is to provide a computer system capable of replacing, when an interest between a shipper and a receiver is quantitatively judged based on at least one of necessity and urgency of commodities not contained in delivery plan information and at least one of necessity and urgency of commodities contained in the delivery plan information, and at least one of necessity and urgency of the commodities not contained in the delivery plan information is high, the commodities to preferentially deliver new commodities.

A representative aspect of this invention is as follows. That is, there is provided a computer system for a delivery system which controls transport means to make the round of bases, thereby delivering commodities to the bases, the computer system comprising: a shipping base terminal installed in a base for shipping the commodities; a reception base terminal installed in a base for receiving the commodities; a transport terminal installed in the transport means; and an information management computer for managing information regarding the commodities to be delivered. The computer system stores attribute information of the commodities to be delivered. The information management computer stores delivery plan information including a plan of delivering the commodities to the reception bases by the transport means; refers to the delivery plan information to judge whether the commodities requested to be delivered are permitted to be loaded on the transport means, upon reception, from the shipping base terminal, of shipping schedule information for requesting delivery of the commodities shipped from the shipping base; refers to attribute information of the commodities requested to be delivered to select commodities to replace with the commodities requested to be delivered from the commodities planned to be delivered, upon judgment that the commodities requested to be delivered are inhibited to be loaded on the transport means; corrects the delivery plan information to replace the selected commodities with the commodities requested to be delivered; and transmits the corrected delivery plan information to the transport terminal, the shipping base terminal, and the reception base terminal. The transport terminal, the shipping base terminal, and the reception base terminal display the delivery plan information transmitted by the information management computer.

According to an embodiment of this invention, a highly efficient delivery plan can be created, the number of transport vehicles can be reduced, and environmental loads can be reduced.

### BRIEF DESCRIPTION OF THE DRAWINGS

The present invention can be appreciated by the description which follows in conjunction with the following figures, wherein:

FIG. 1 is a diagram showing a configuration of a joint delivery information management system in accordance with a first embodiment of this invention;

FIG. 2 is a block diagram showing a configuration of computers installed in the joint delivery information management system in accordance with the first embodiment of this invention;

FIG. 3A is an explanatory diagram showing a configuration of the shipping schedule information table in accordance with the first embodiment of this invention;

FIG. 3B is an explanatory diagram showing a configuration of the shipping scheduled commodity information table in accordance with the first embodiment of this invention;

FIG. 4 is an explanatory diagram showing a configuration of the commodity tracing information table in accordance with the first embodiment of this invention;

FIG. 5A is an explanatory diagram showing a configuration of the delivery plan information table in accordance with the first embodiment of this invention;

FIG. 5B is an explanatory diagram showing a configuration of the delivery plan base table in accordance with the first embodiment of this invention;

FIG. 5C is an explanatory diagram showing a configuration of the delivery plan commodity table in accordance with the first embodiment of this invention;

FIG. 6 is a sequence diagram showing the joint delivery information management system in accordance with the first embodiment of this invention;

FIG. 7 is a flowchart of the shipping schedule registration process executed by the information management server in accordance with the first embodiment of this invention;

FIG. 8 is an explanatory diagram showing a configuration of the shipping schedule registration request screen in accordance with the first embodiment of this invention;

FIG. 9 is a flowchart of a process of providing delivery information, arrival information, and shipping information in accordance with the first embodiment of this invention;

FIG. 10 is an explanatory diagram showing a configuration of a delivery plan information/achievement information screen in accordance with the first embodiment of this invention;

FIG. 11 is an explanatory diagram showing a configuration of the each-commodity achievement information screen in accordance with the first embodiment of this invention;

FIG. 12 is a block diagram of each computer installed in a joint delivery information management system in accordance with a second embodiment of this invention;

FIG. 13 is an explanatory diagram showing a configuration of a plan correction history table stored in the plan correction history DB in accordance with the second embodiment of this invention;

FIG. 14 is an explanatory diagram showing a configuration of each-base use point information stored in the each-base use point DB in accordance with the second embodiment of this invention;

FIG. 15 is a flowchart of the process of creating or changing the each-base use point table by the information management server in accordance with the second embodiment of this invention; and

FIG. 16 is an explanatory diagram showing a configuration of the point setting file in accordance with the second embodiment of this invention.

### DETAILED DESCRIPTION OF THE PREFERRED EMBODIMENTS

The preferred embodiments of this invention will be described below.

### First Embodiment

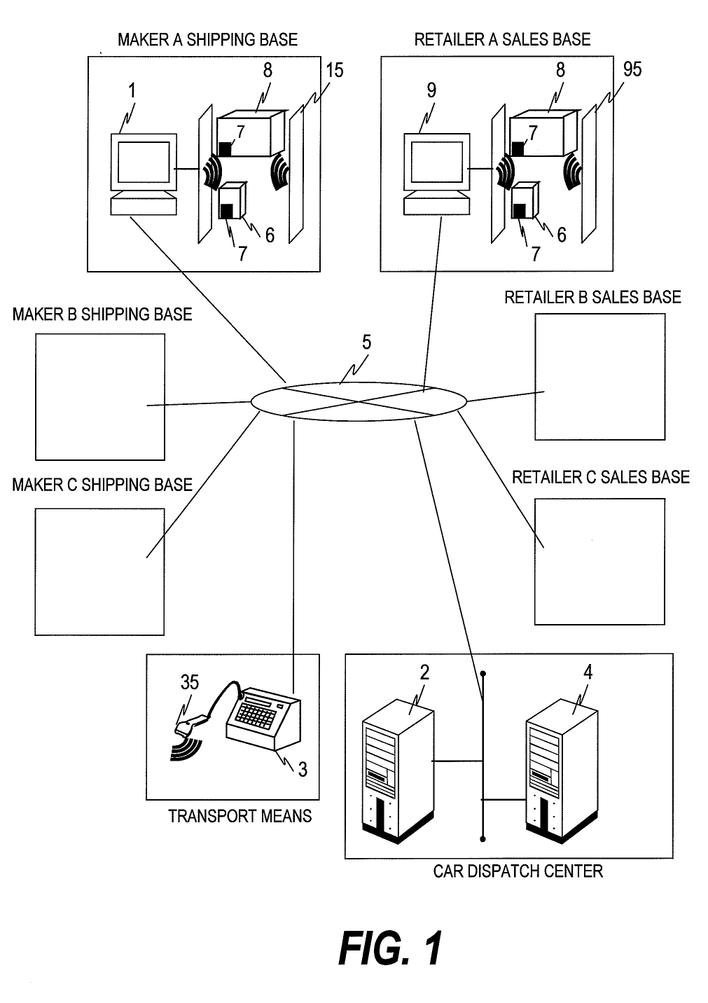

FIG. 1 illustrates a configuration of a joint delivery information management system according to a first embodiment of this invention.

The joint delivery information management system includes a maker base terminal 1, an information management server 2, an on-vehicle terminal 3, a delivery plan making server 4, and a retailer base terminal 9.

The information management server 2 and the delivery plan making server 4 are installed in a car dispatch center of a distribution company or the like. The maker base terminal 1 is installed in a base which ships commodities. The maker base terminal 1 may be installed in a maker shipping base, a maker head office, or the like. The retailer base terminal 9 is installed at a base which receives commodities. For example, the retailer base terminal 9 may be installed in a sales base or a head office of a retailer. The on-vehicle terminal 3 is installed in transport means such as a truck for delivering commodities.

The maker base terminal 1, the information management server 2, the on-vehicle terminal 3, the delivery plan making server 4, and the retailer base terminal 9 are interconnected through a network 5. The network 5 is, for example, Internet. The maker base terminal 1, the information management server 2, the on-vehicle terminal 3, the delivery plan making server 4, and the retailer base terminal 9 may be interconnected by wire or wireless.

Upon reception of order information of commodities to be transmitted by the retailer base terminal 9, the maker base terminal 1 transmits a request of registering commodities to be shipped to the information management server 2. The information management server 2 that has received the request of registering the commodities to be shipped controls the delivery plan making server 4 to generate delivery plan information. The information management server 2 transmits the delivery plan information created by the delivery plan making server 4 to the on-vehicle terminal 3, the maker base terminal 1, and the retailer base terminal 9. The transport means in which the on-vehicle terminal 3 has been installed delivers the commodities to a maker base and a retailer base based on the received delivery plan information.

Each of the maker base terminal 1, the information management server 2, the on-vehicle terminal 3, the delivery plan making server 4, and the retailer base terminal 9 is a computer which includes an processing unit, a storage unit, and a network interface. The processing unit performs various arithmetic operations. The processing unit is, for example, a central processing unit (CPU). The storage unit stores programs executed by the processing unit, or the like. The storage unit is, for example, a memory. The memory is, for example, a random access memory (RAM). Those computers communicate with each other via the network interfaces.

The maker base terminal 1 receives order information transmitted from the retailer base terminal 9 for requesting order of commodities. Upon reception of the order information, the maker base terminal 1 transmits shipping schedule registration request information which is a request of registering commodities to be shipped in the information management server 2 to the information management server 2 based on the order information. When a maker shipping base actually ships commodities, the maker base terminal 1 transmits shipped commodity information to the information management server 2. The maker base terminal 1 refers to the delivery plan information notified from the information management server 2.

The retailer base terminal 9 transmits order information for requesting order of commodities wished to be shipped to the maker base terminal 1. When the retailer base actually receives commodities, the retailer base terminal 9 transmits arrival information to the information management server 2. The retailer base terminal 9 refers to the delivery plan information notified from the information management server 2.

A non-contact integrated circuit (IC) tag (hereinafter, referred to as IC tag) 7 is attached to the commodities shipped from the maker base. A storage system disposed in the IC tag 7 stores unique ID for uniquely identifying the IC tag 7.

The maker base terminal 1 includes an antenna 15 for reading the unique ID from the IC tag 7 attached to the commodities. The retailer base terminal 9 similarly includes an antenna 95 for reading the unique ID from the IC tag 7 attached to the commodities. In place of being attached to the commodities, the IC tag 7 may be linked to the commodities with a string or the like.

The maker base terminal 1 and the retailer base terminal 9 read the IC tag 7 to obtain unique ID which is a unique identifier of the IC tag 7. Based on the obtained unique ID, the maker base terminal 1 and the retailer base terminal 9 can uniquely identify the commodities shipped or received.

Based on the obtained unique ID, the maker base terminal 1 generates shipping achievement information containing shipping date and time to transmit it to the information management server 2. The retailer base terminal 9 similarly generates receiving achievement information containing received date and time to transmit it to the information management server 2.

When a commodity 6 is packed by a transport package 8 to be shipped, an IC tag 7 is attached to the transport package 8. Then, the maker base terminal 1 and the retailer base terminal 9 read the IC tag 7 attached to the transport package 8. Accordingly, the packed commodity is associated with the transport package 8. The transport package 8 is, for example, a cardboard or a folded container. Commodities include the commodity 6 and the transport package 8 hereinafter.

The information management server 2 receives the shipping schedule registration request information transmitted from the maker base terminal 1 to store it in a database. The information management server 2 transmits the received shipping schedule registration request information to the delivery plan making server 4. Then, the information management server 2 receives delivery plan information created by the delivery plan making server 4 to store it in the database. The information management sever 2 transmits the received delivery plan information to the maker base terminal 1, the on-vehicle terminal 3, and the retailer base terminal 9.

The information management server 2 receives shipped commodity information transmitted from the maker base terminal 1 and receiving base commodity information transmitted from the retailer base terminal 9 to store the received pieces of information in the database.

The information management server 2 receives request of inquiries about information of delivered achievements from the maker base terminal 1, the on-vehicle terminal 3, and the retailer base terminal 9. The information management server 2 generates information of delivered achievements based on the shipped commodity information and the receiving base commodity information stored in the database. The information management server 2 transmits the generated information of delivered achievements to the maker base terminal 1, the on-vehicle terminal 3, and the retailer base terminal 9 which have transmitted the requests.

The on-vehicle terminal 3 includes a wireless communication function. The on-vehicle terminal 3 receives the delivery plan information transmitted from the information management server 2. The on-vehicle terminal 3 is coupled to an antenna 35 capable of reading an IC tag 7. The on-vehicle terminal 3 reads the IC tag 7 attached to commodities on a loading platform of the transport means via the antenna 35. Accordingly, a user of the on-vehicle terminal 3 can effectively sort the commodities on the loading platform.

The delivery plan making server 4 receives the shipping schedule registration request information from the information management server 2. The delivery plan making server 4 generates joint delivery plan information based on the received shipping schedule registration request information. The delivery plan making server 4 transmits the created joint delivery plan to the information management server 2.

The information management server 2 and the delivery creation server 4 may be installed not in the same place but in other places. The maker base terminal 1, the retailer base terminal 9, the information management server 2, and the delivery plan making server 4 may be housed in one casing.

It has been described that the process of reading the unique ID from the IC tag 7, the process of transmitting the reading result of the IC tag 7 to the information management server 2, the process of transmitting the shipping schedule information to the information management server 2, and the process of referring to the achievement information are carried out by the same maker base terminal 1. However, those processes may be carried out by other maker base terminals 1.

Similarly, it has been described that the process of reading the unique ID from the IC tag 7, the process of transmitting the reading result of the IC tag 7 to the information management server 2, and the process of referring to the achievement information are carried out by the same retailer base terminal 9. However, those processes may be carried out by other retailer base terminals 9.

The joint delivery information management system may further include a terminal (not shown) for changing setting information of the maker base terminal 1, the information management server 2, the on-vehicle terminal 3, the delivery plan making server 4, and the retailer base terminal 9.

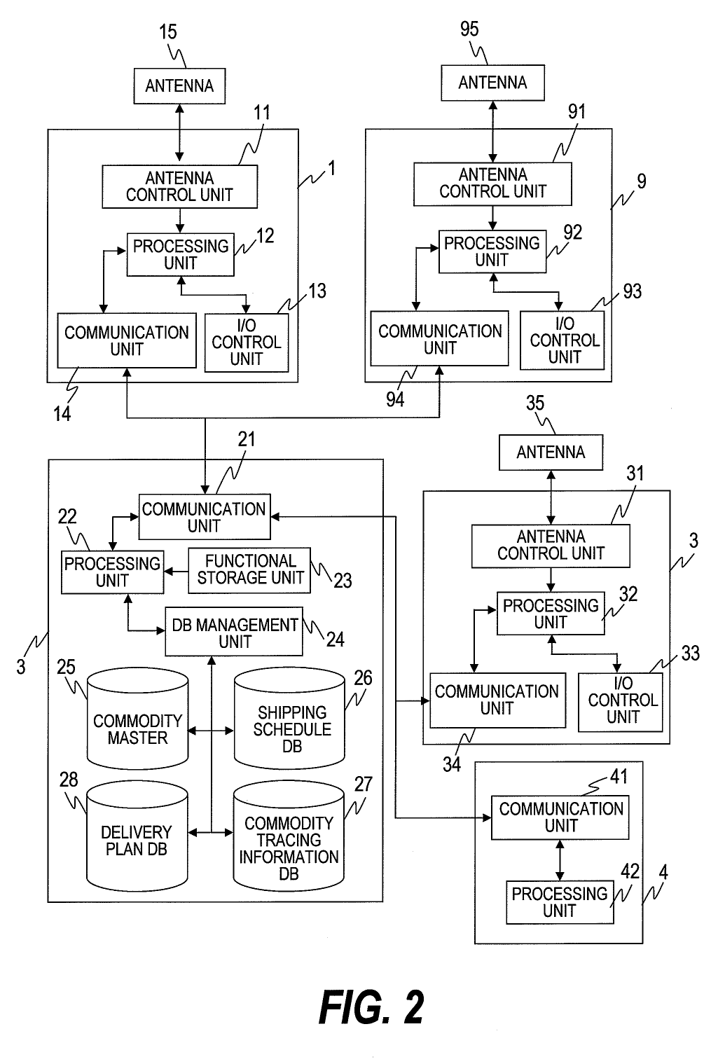

FIG. 2 is a block diagram a configuration of computers installed in the joint delivery information management system according to the first embodiment of this invention.

The maker base terminal 1 includes a tag reader 11, an processing unit 12, an I/O control unit 13, a communication unit 14, and an antenna 15.

The processing unit 12 performs various arithmetic operations. The processing unit 12 includes an arithmetic processing unit and a storage unit. The I/O control unit 13 receives an entry from a user to output information to the user. For example, the I/O control unit 13 is a keyboard or a display. The communication unit 14 couples the maker base terminal 1 to the network 5.

The tag reader 11 transmits a tag reading command to the antenna 15. Upon reception of the tag reading command from the tag reader 11, the antenna 15 reads a tag. The antenna 15 transmits a result of reading the tag to the processing unit 12 via the tag reader 11.

Upon reception of the tag reading result via the tag reader 11, the processing unit 12 adds information about preset reading time or base name to the received tag reading result. The processing unit 12 transmits the tag reading result containing the information about reading time or base name as shipping information to the communication unit 14.

The processing unit 12 transmits screen information (e.g., delivery plan or arrival information) received from the information management server 2 via the communication unit 14. The processing unit 12 transmits information entered via the I/O control unit 13 to the communication unit 14.

Upon reception of the screen information transmitted from the processing unit 12, the I/O control unit 13 displays the received screen information in the display. The I/O control unit 13 receives an entry from the user to transmit it as input information to the processing unit 12.

Upon reception of various pieces of information transmitted from the information management server 2, the communication unit 14 transmits the received various pieces of information to the processing unit 12. Upon reception of various pieces of information transmitted from the processing unit 12, the communication unit 14 transmits the received various pieces of information to the information management server 2. The communication unit 14 is, for example, a network interface.

The information management server 2 includes a communication unit 21, an processing unit 22, a communication storage unit 23, a DB management unit 24, a commodity master 25, a shipping schedule database (DB) 26, a commodity tracing information database (DB) 27, and a delivery plan database (DB) 28.

The communication unit 21 receives various pieces of information transmitted from the maker base terminal 1, the retailer base terminal 9, the on-vehicle terminal 3, and the delivery plan making server 4 to transmit the received pieces of information to the processing unit 22. Upon reception of information transmitted from the processing unit 22, the communication unit 21 transmits the received information to the maker base terminal 1, the retailer base terminal 9, the on-vehicle terminal 3, and the delivery plan making server 4. The communication unit 21 is, for example, a network interface.

The processing unit 22 includes an arithmetic processing unit and a storage unit. Upon reception of shipping schedule registration request information and shipping achievement information transmitted from the maker base terminal 1, to store the received shipping schedule registration request information and shipping achievement information in a database, the processing unit 22 transmits the received shipping schedule registration request information and shipping achievement information to the DB management unit 24. Upon reception of reception achievement information transmitted from the retailer base terminal 9, to store the received reception achievement information in the database, the processing unit 22 transmits the received reception achievement to the DB management unit 24.

Upon reception of shipping schedule information to be stored in the shipping schedule DB 26 from the DB management unit 24, the processing unit 22 transmits the received shipping schedule information to the delivery plan making server 4 via the communication unit 21. Upon reception of delivery plan information transmitted from the delivery plan making server 4 via the communication unit 21, the processing unit 22 transmits the received delivery plan information to the DB management unit 24 to store it in a delivery plan DB 28. The processing unit 22 transmits the received delivery plan information to the maker base terminal 1, the retailer base terminal 9, and the on-vehicle terminal 3 via the communication unit 21.

Upon reception of requests of inquiries about achievement information of commodities from the maker base terminal 1, the retailer base terminal 9, and the on-vehicle terminal 3 via the communication unit 21, the processing unit 22 obtains achievement information that matches the requests via the DB management unit 24. The processing unit 22 generates screen information for displaying the obtained achievement information, and transmits the generated screen information of the achievement information to the maker base terminal 1, the retailer base terminal 9, and the on-vehicle terminal 3.

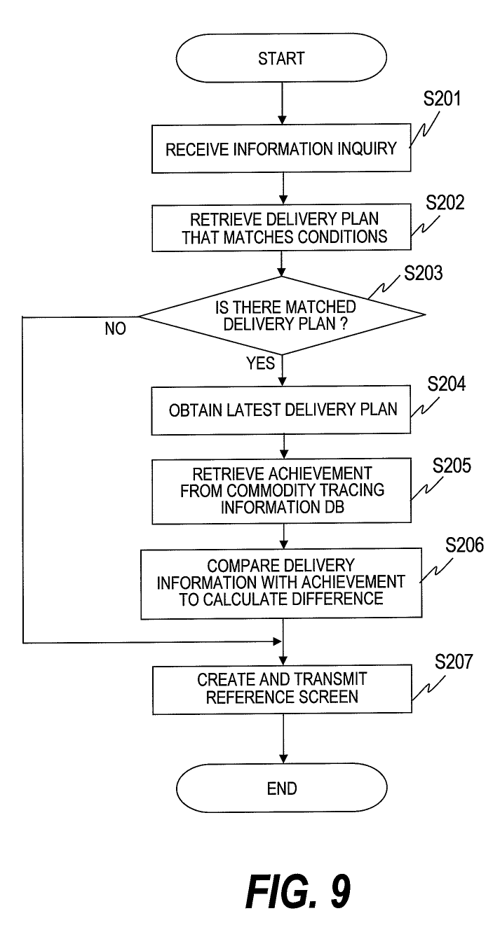

Those processes are carried out by loading applications stored in the functional storage unit 23 in the memory installed in the processing unit 22 by the processing unit 22. Referring to FIG. 9, this operation will be described in detail.

The functional storage unit 23 stores an application executed by the information management server 2. The functional storage unit 23 stores a setting file for storing a parameter or the like. According to a request from the processing unit 22, the functional storage unit 23 loads a processing procedure of the application and the setting file in the memory of the processing unit 22.

According to a request from the processing unit 22, the DB management unit 24 stores the shipping schedule request information transmitted from the processing unit 22 as shipping schedule information in the shipping schedule DB 26. According to a request from the processing unit 22, the DB management unit 24 stores the shipping achievement information and the reception achievement information transmitted from the processing unit 22 in the commodity tracing information DB 27. According to a request from the processing unit 22, the DB management unit 24 stores the delivery plan information transmitted from the processing unit 22 to the delivery plan DB 28.

According to a request from the processing unit 22, the DB management unit 24 retrieves pieces of information stored in the commodity master 25, the shipping schedule DB 26, the commodity tracing information DB 27, and the delivery plan DB 28 to transmit the retrieved pieces of information to the processing unit 22.

Four databases managed by the DB management unit 24 will be described below.

The commodity master 25 stores basic information of commodities 6 of all makers which become targets of joint delivery. Specifically, the commodity master 25 stores a unique ID mapping table for mapping unique ID stored in IC tags 7 and commodity codes. Accordingly, the information management server 12 can identify commodities 6 from reading results of the IC tags 7 attached to the commodities 6. The commodity master 25 stores a commodity name, a price, a commodity classification, and a commodity volume for each commodity code. When the IC tag 7 stores unique ID and a commodity code, the unique ID mapping table may not be stored in the commodity master 25.

By transmitting information stored in the commodity master 25 to the maker base terminal 1, the retailer base terminal 9, and the on-vehicle terminal 3 via the communication unit 21, the maker base terminal 1, the retailer base terminal 9, and the on-vehicle terminal 3 can quickly identify a commodity code, a commodity name, or the like of the commodity 6 from a reading result of the IC tag 7 attached to the commodity 6.

The shipping schedule DB 26 stores shipping schedule information containing a volume of commodities which become targets of joint delivery, and a name of a receiver. Upon reception of the shipping schedule registration request information entered from the maker base terminal 1, the information management server 2 stores the received shipping schedule registration request information as shipping schedule information in the shipping schedule DB 26.

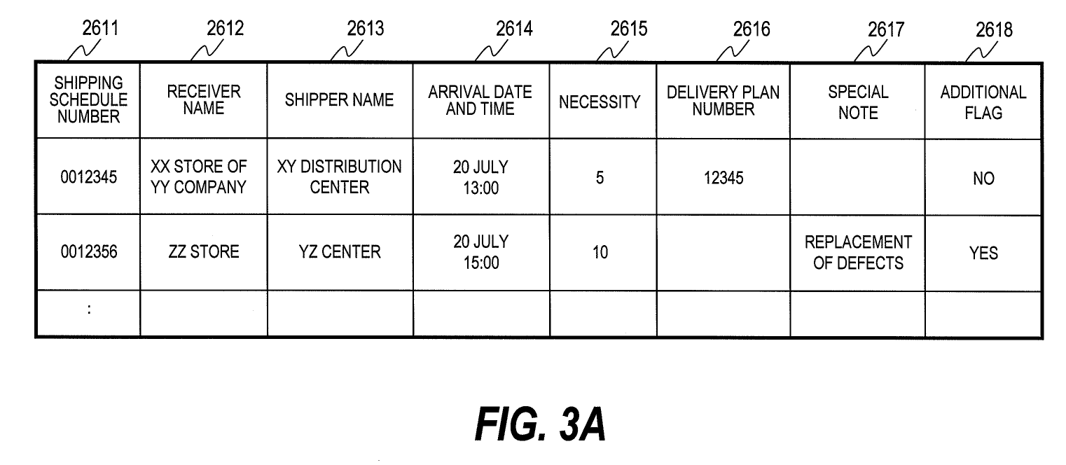

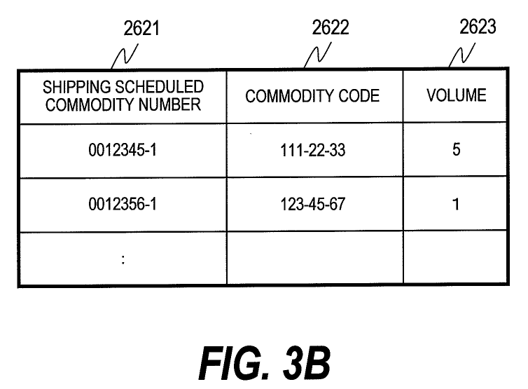

Specifically, the shipping schedule DB 26 stores a shipping schedule information table 261 and a shipping scheduled commodity information table 262. Referring to FIG. 3A, the shipping schedule information table 261 will be described in detail. Referring to FIG. 3B, the shipping scheduled commodity information table 262 will be described in detail.

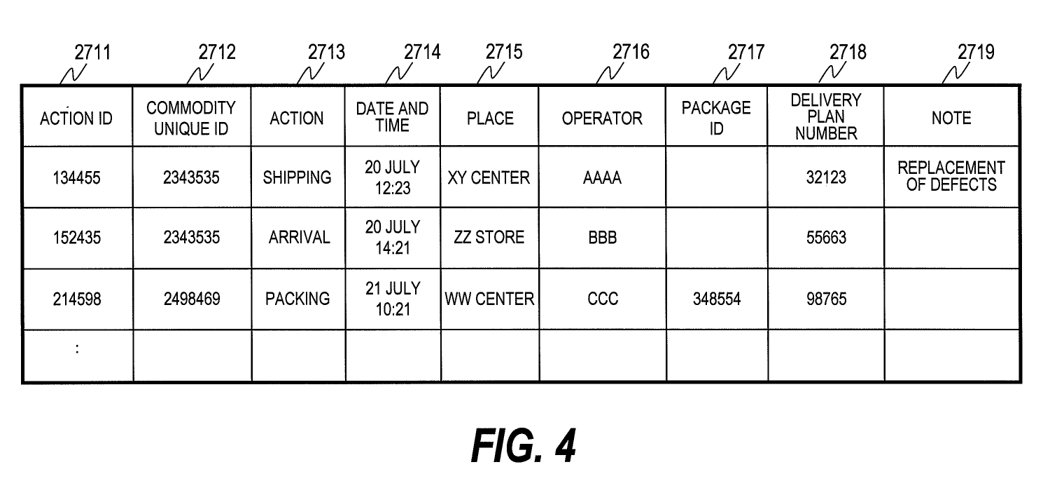

The commodity tracing information DB 27 stores a commodity tracing information table 271 indicating shipping or receiving achievements for each commodity. Referring to FIG. 4, the commodity tracing information table 271 will be described in detail.

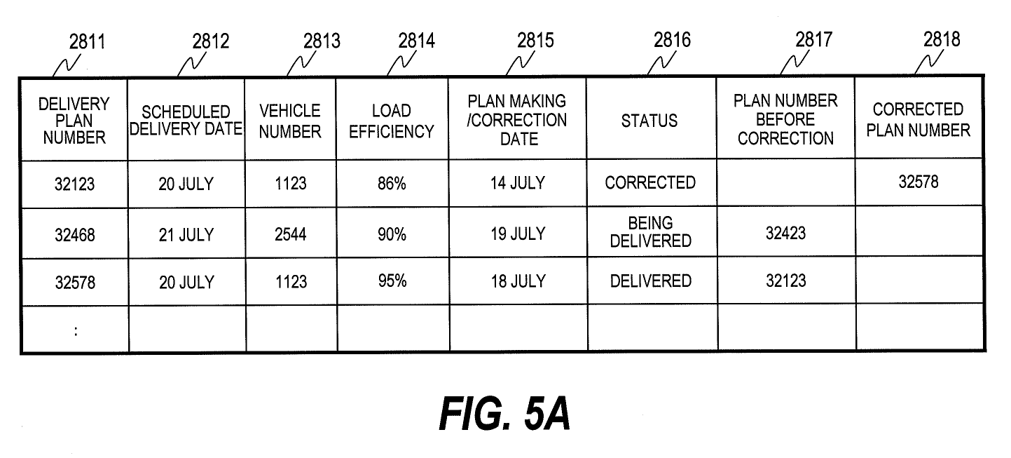

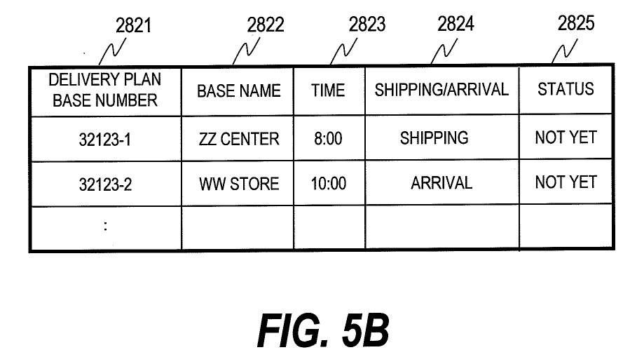

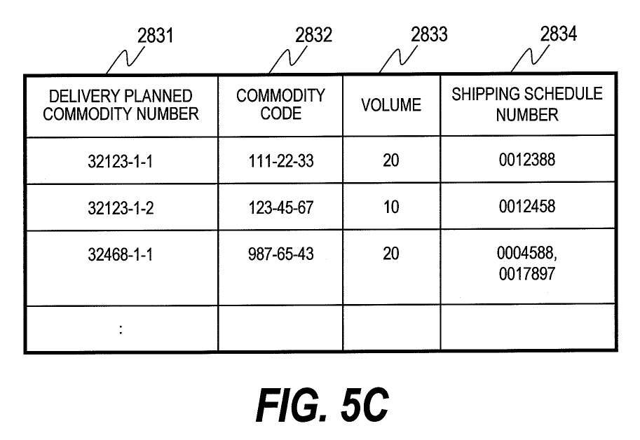

The delivery plan DB 28 stores a delivery plan information table 281 indicating the delivery plan information generated by the delivery plan making server 4, a delivery plan base table 282, and a delivery plan commodity table 283. Referring to FIG. 5A, the delivery plan information table 281 will be described in detail. Referring to FIG. 5B, the delivery plan base table 282 will be described in detail. Referring to FIG. 5C, the delivery plan commodity table 283 will be described in detail.

The information management server 2 may further include a vehicle master database (DB) for storing information indicating a loading capacity of a delivery vehicle, and a transport cost database (DB) for storing information indicating transport costs for joint delivery for each base.

The on-vehicle terminal 3 will be described below.

The on-vehicle terminal 3 includes a tag reader 31, an processing unit 32, an I/O control unit 33, a communication unit 34, and an antenna 35.

The tag reader 31 transmits a tag reading command to the antenna 35. Upon reception of the tag reading command from the tag reader 31, the antenna 35 reads a tag. The antenna 35 transmits a result of reading the tag to the processing unit 32 via the tag reader 31.

The processing unit 32 includes an arithmetic processing unit and a storage unit. Upon reception of the tag reading result via the tag reader 31, the processing unit 32 refers to the received reading result of the tag 7 and the delivery plan information transmitted from the information management server 2 to specify a commodity 6 or a package 8 to be unloaded at a next base. When unique ID received by the on-vehicle terminal 3 and stored in the commodity master 25 of the information management server 2 matches unique ID contained in the reading result of the tag 7, the processing unit 32 transmits a message indicating that the commodity 6 or the package 8 having the tag 7 is a known commodity to the I/O control unit 33.

The I/O control unit 33 displays the message transmitted from the processing unit 32 or the like. Accordingly, the user can understand whether the commodity 6 or the package 8 from which the tag 7 has been read is a target of sorting or carrying-out. The I/O control unit 33 is, for example, a network interface.

The communication unit 34 transmits the delivery plan information transmitted from the information management server 2 to the processing unit 32.

The delivery plan making server 4 will be described below.

The delivery plan making server 4 includes a communication unit 41 and an processing unit 42. The processing unit 42 includes an arithmetic processing unit and a storage unit.

The communication unit 41 receives the request of generating delivery plan information and the shipping schedule information transmitted from the information management server 2, and transmits the received request of generating delivery plan information and shipping schedule information to the processing unit 42. If necessary, the communication unit 41 receives the delivery plan information stored in the information management server 2 to transmit it to the processing unit 42. The communication unit 41 transmits delivery plan information generated by the processing unit 42 to the information management server 2. The communication unit 41 is, for example, a network interface.

The delivery plan making server 4 may include a function necessary for generating delivery plan information, and a database.

FIG. 3A illustrates a configuration of the shipping schedule information table 261 according to the first embodiment of this invention.

The shipping schedule information table 261 includes a shipping schedule number 2611, a receiver name 2612, a shipper name 2613, arrival date and time 2614, necessity 2615, a delivery plan number 2616, a special note 2617, and an additional flag 2618.

Each record registered in the shipping schedule information table 261 indicates shipping schedule information.

A number for uniquely identifying shipping schedule information is registered in the shipping schedule number 2611. A name indicating a receiver base is registered in the receiver name 2612. A name indicating a shipper base is registered in the shipper name 2613.

In the arrival date and time 2614, scheduled date and time when commodities arrive at the receiver base registered in the receiver name 2612 are registered. In the necessity 2615, a numerical value indicating necessity of shipped commodities is registered. The shipping schedule information table 261 may include, in addition to the necessity 2615, urgency in which a numerical value indicating urgency of commodities to be shipped is registered.

In the delivery plan number 2616, a number for uniquely identifying delivery plan information corresponding to each record is registered. In the special note 2617, an item to be specially described is registered. In the special note 2617, for example, information indicating shipping for replacing defects is registered. In the additional flag 2618, information indicating whether new delivery plan information has to be generated is registered.

FIG. 3B illustrates a configuration of the shipping scheduled commodity information table 262 according to the first embodiment of this invention.

The shipping scheduled commodity information table 262 includes a shipping scheduled commodity number 2621, a commodity code 2622, and a volume 2623.

Each record registered in the shipping scheduled commodity information table 262 indicates commodities scheduled to be shipped. Information of the commodities scheduled to be shipped which is registered in the shipping scheduled commodity information table 262 is associated with the shipping schedule information registered in the shipping schedule information table 261.

In the shipping scheduled commodity number 2621, a number for uniquely identifying a commodity scheduled to be shipped is registered. The number registered in the shipping scheduled commodity number 2621 includes “-.” When a number before the number “-” registered in the shipping scheduled commodity number 2621 matches the number registered in the shipping schedule number 2611, it means that a record including this shipping scheduled commodity number 2621 is associated with a record including the shipping schedule number 2611. Information of one or more commodities scheduled to be shipped is associated with one piece of shipping schedule information.

In the commodity code 2622, a commodity code of a commodity scheduled to be shipped is registered. In the volume 2626, the number of commodities scheduled to be shipped is registered.

FIG. 4 illustrates a configuration of the commodity tracing information table 271 according to the first embodiment of this invention.

The commodity tracing information table 271 includes action ID 2711, commodity unique ID 2712, an action 2713, a date and time 2714, a place 2715, an operator 2716, package ID 2717, a delivery plan number 2718, and a note 2719.

Each record registered in the commodity tracking information table 271 indicates action information. The action information indicates an achievement (e.g., shipping or receiving) of a unit of a commodity 6 or a package 8 to which an IC tag 7 is attached.

In the action ID 2711, a unique identifier of action information is registered. In the commodity unique ID 2712, unique ID stored in an IC tag 7 read by the antenna 15, 35 or 95 is registered. In other words, in the commodity unique ID 2712, unique ID stored in the IC tag 7 attached to the commodity 6 or the package 8 which is an action target is registered.

In the action 2713, information indicating action contents is registered. In the action 2713, specifically, “SHIP,” “RECEIVE,” or “PACK” is registered. In the date and time 2714, a date and time of action for the commodity 6 or the package 8 is registered. In the place 2715, information indicating an action place of the commodity 6 or the package 8 is registered. In the place 2715, specifically, a name of a maker base, a name of a sales base, or the like is registered.

In the operator 2716, a name of an operator of the action of the commodity 6 or the package 8 is registered. In the package ID 2717, in the case of a record in which “PACK” is registered in the action 2713, unique ID stored in the IC tag 7 attached to the package 8 is registered. The unique ID registered in the package ID 2717 is associated with unique ID stored in the IC tag 7 attached to the commodity 6.

In the delivery plan number 2718, a number for uniquely identifying delivery plan information corresponding to the action information is registered. In the note 2719, information indicating a note to be specially described corresponding to the action information is registered. For example, in the note 2719, “DEFECT REPLACEMENT” is registered.

FIG. 5A illustrates a configuration of the delivery plan information table 281 according to the first embodiment of this invention.

Each record registered in the delivery plan information table 281 indicates header information of delivery plan information.

The delivery plan information table 281 includes a delivery plan number 2811, a scheduled delivery date 2812, a vehicle number 2813, load efficiency 2814, a plan making/correction date 2815, a status 2816, a plan number before correction 2817, and a corrected plan number 2818.

In the delivery plan number 2811, a number for uniquely identifying delivery plan information is registered. In the scheduled delivery date 2812, a scheduled date of delivering the commodity 6 or the package 8 is registered. In the vehicle number 2813, a number for uniquely identifying a vehicle to deliver the commodity 6 or the package 8 is registered. In the load efficiency 2814, when maximum load efficiency of the vehicle to deliver the commodity 6 or the package 8 is 100%, load efficiency of the commodity 6 or the package 8 determined based on the delivery plan information is registered.

In the plan making/correction date 2815, a month and a date of generating the delivery plan information is registered. When the delivery plan information is corrected, in the plan making/correction date 2815, a month and a date of correcting the delivery plan information is registered.

In the status 2816, information indicating a status such as a progress of the delivery plan information is registered. In the status 2816, specifically, “CORRECTED,” “BEING DELIVERED,” or “DELIVERED” is registered. The “CORRECTED” indicates that the delivery plan information has been corrected. The “BEING DELIVERED” indicates on-going delivery of the commodity 6 or the package 8 determined to be delivered based on the delivery plan information. The “DELIVERED” indicates that all the commodities 6 or the packages 8 determined to be delivered based on the delivery plan information have been delivered.

In the plan number before correction 2817, when delivery plan information of a given record is delivery plan information after correction, a number for uniquely identifying delivery plan information before the correction is registered. In the corrected plan number 2818, when delivery plan information of a given record is delivery plan information before correction, a number for uniquely identifying delivery plan information after the correction is registered.

FIG. 5B illustrates a configuration of the delivery plan base table 282 according to the first embodiment of this invention.

The delivery plan base table 282 includes a delivery plan base number 2821, a base name 2822, time 2823, and shipping/arrival 2824, and a status 2825.

Each record registered in the delivery plan base table 282 indicates information of a base which becomes a target of delivery plan information.

In the delivery plan base number 2821, a number for uniquely identifying information of a base which becomes a target of a delivery plan. Information of commodities scheduled to be shipped which is registered in the delivery plan base table 282 is associated with the delivery plan information registered in the delivery plan information table 281.

The number registered in the delivery plan base number 2821 includes “-.” When a number before “-” in the number registered in the delivery plan base number 2821 matches the number registered in the delivery plan number 2811, it means that a record including this delivery plan base number 2821 is associated with a record including the delivery plan number 2811. Information of one or more bases which become delivery plan targets are associated with one piece of delivery plan information.

In the base name 2822, a name of a base which becomes a target of the delivery plan information is registered. In the time 2823, scheduled arrival time of a vehicle at the base of the name registered in the base name 2822 is registered.

In the shipping/arrival 2824, information indicating which of a base for shipping the commodity 6 or the package 8 and a base for receiving the commodity 6 or the package 8 the base of the name registered in the base name 2822 is. Specifically, if “SHIPPING” is registered in the shipping/arrival 2824, a relevant base is a base for shipping the commodity 6 or the package 8. On the other hand, if “ARRIVING” is registered in the shipping/arrival 2824, a relevant base is a base for receiving the commodity 6 or the package 8.

In the status 2825, information indicating whether delivery has been finished is registered. If “NOT YET” is registered in the status 2825, it means that delivery has not been finished. On the other hand, if “FINISHED” is registered in the status 2825, it means that delivery has been finished.

FIG. 5C illustrates a configuration of the delivery plan commodity table 283 according to the first embodiment of this invention.

The delivery plan commodity table 283 includes a delivery planned commodity number 2831, a commodity code 2832, volume 2833, and a shipping schedule number 2834.

Each record registered in the delivery plan commodity table 283 indicates information of a commodity which becomes a target of delivery plan information.

In the delivery planned commodity number 2831, a number for uniquely identifying a commodity which becomes a target of a delivery plan information. Information of commodities scheduled to be shipped which is registered in the delivery plan base table 282 is associated with the delivery plan information registered in the delivery plan information table 281.

The number registered in the delivery planned commodity number 2831 includes “-.” When a number before “-” in the number registered in the delivery planned commodity number 2831 matches the number registered in the delivery plan base number 2821, it means that a record including this delivery planned commodity number 2831 is associated with a record including the delivery plan base number 2821. Delivery planned commodity number of one or more bases are associated with one piece of delivery plan base information.

In the commodity code 2832, a commodity code of a commodity which becomes a target of a delivery plan is registered. In the volume 2833, a volume of commodities which become targets of the delivery plan is registered. In the shipping schedule number 2834, a number registered in the shipping schedule number 2611 corresponding to a commodity which becomes a target of the delivery plan is registered.

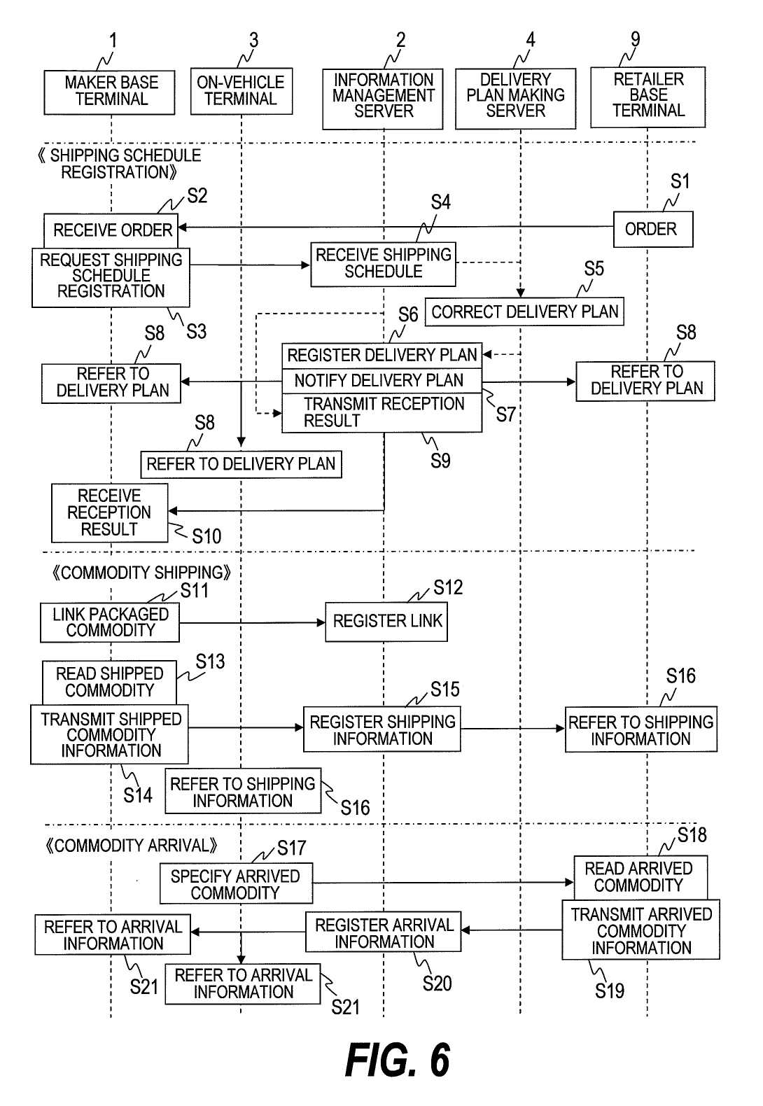

FIG. 6 is a sequence diagram of the joint delivery information management system according to the first embodiment of this invention.

First, a sequence of a shipping schedule registration request process executed by the joint delivery information management system will be described.

Upon entry of order information, the retailer base terminal 9 transmits the order information to the maker base terminal 1 (S1). The order information may be directly transmitted to the maker base by telephone or facsimile.

Upon reception of the order information (S2), the maker base terminal 1 generates shipping schedule registration request information to transmit it the information management server 2 (S3).

Upon reception of the shipping schedule registration request information as shipping schedule information (S4), the information management server 2 judges, based on the received shipping schedule information, whether to correct the delivery plan information. If it is judged that the delivery plan information does not have to be corrected, the information management server 2 proceeds to a step S9.

On the other hand, if it is judged that the delivery plan information has to be corrected, the information management server 2 obtains the delivery plan information to be corrected from the delivery plan DB 28. Then, the information management server 2 transmits the obtained delivery plan information and the shipping schedule information received in the step S4 to the delivery plan making server 4.

Upon reception of the delivery plan information and the shipping schedule information transmitted from the information management server 2, the delivery plan making server 4 corrects delivery plan information of a correction target based on the received shipping schedule information (S5). Then, the delivery plan making server 4 transmits the corrected delivery plan information to the information management server 2.

Upon reception of the corrected delivery plan information, the information management server 2 stores the received delivery plan information in the delivery plan DB 28 (S6). When correction is carried out to replace commodities to be delivered, the information management server 2 stores shipping schedule information 261 corresponding to replacing commodities and shipping schedule information 261 corresponding to replaced commodities in the shipping schedule DB 26.

In order to notify the correction of the delivery plan information, the information management server 2 transmits the corrected delivery plan information to the maker base terminal 1, the retailer base terminal 9, and the on-vehicle terminal 3 (S7) to proceed to a step S9.

Upon reception of the corrected delivery plan information, the maker base terminal 1, the retailer base terminal 9, and the on-vehicle terminal 3 refer to the corrected delivery plan information (S8).

Then, the information management server 2 transmits information indicating reception of the shipping schedule registration request information to the maker base terminal 1 (S9).

The maker base terminal 1 receives information indicating the reception of the shipping schedule registration request information transmitted from the information management server 2 (S10) to finish the shipping schedule registration request process.

The information management server 2 periodically transmits the shipping schedule information stored in the shipping schedule DB 26 to the delivery plan making server 4. The delivery plan making server 4 periodically receives the shipping schedule information to generate delivery plan information. The delivery plan making server 4 transmits the generated delivery plan information to the information management server 2. Upon reception of the generated delivery plan information, the information management server 2 stores the received delivery plan information in the delivery plan DB 28.

A sequence of a commodity shipping process executed by the joint delivery information management system will be described below.

When a plurality of commodities 6 are packed and one transport package 8 is delivered, before the commodities 6 are shipped, unique ID stored in an IC tag 7 attached to the transport package 8 is associated with unique ID stored in IC tags 7 attached to the commodities 6 packed in the transport package 8. The maker base terminal 1 reads the IC tag 7 attached to the transport package 8 and the IC tags 7 attached to the commodities 6 packed in the transport package 8 to transmit a reading result to the information management server 2 (S11).

Upon reception of the reading result of the IC tag 7 attached to the transport package 8 and the IC tags 7 attached to the commodities 6 packed in the transport package 8, the information management server 2 stores the received reading result in the commodity tracing information DB 27 (S12).

Accordingly, when the transport package 8 is shipped or received, by reading the IC tag 7 attached to the transport package 8, action information of the commodities 6 packed in the transport package 8 is stored in the commodity tracing information DB 27.

When the commodities 6 or the transport package 8 is shipped from the maker base, the IC tags 7 attached to the commodities 6 to be shipped or the IC tag 7 attached to the transport package 8 is read by the antenna 15 installed in the maker base terminal 1 (S13).

In this case, the maker base terminal 1 refers to the delivery plan information stored in the delivery plan DB 28 of the information management server 2, and compares the delivery plan information with the reading result of the IC tag 7 to check whether there is an excess or a shortage of the commodities 6 to be shipped or the transport package 8 to be shipped.

The maker base terminal 1 transmits the time of reading the IC tag 7, a name of a base for reading the IC tag 7, and shipping information added to the reading result to the information management server 2 (S14).

Upon reception of the shipping information transmitted from the maker base terminal 1, the information management server 2 stores the received shipping information as shipping achievement information in the commodity tracing information DB 27 (S15). The information management server 2 updates the status 2825 of a record corresponding to the received shipping information to “FINISHED” among records registered in the delivery base terminal 282 stored in the delivery plan DB 28.

The retailer base terminal 9, the on-vehicle terminal 3, and the maker base terminal 1 transmit a request of referring to the shipping achievement information to the information management server 2 to refer to the shipping achievement information stored in the commodity tracing information DB 27 (S16). Accordingly, up to which of the bases the delivery vehicle has finished collection of commodities, and what volume of commodities 6 or a transport package 8 has been loaded on the loading means can be understood.

A sequence of a commodity receiving process executed by the joint delivery information management system will be described.

Upon arrival of the transport means at a retailer base such as a retailer, via the on-vehicle terminal 3, referring to the delivery plan information and the achievement information stored in the information management server 2, which of the commodities 6 or the transport packages 8 loaded on the transport means should be unloaded from the transport means is specified by reading IC tags 7 attached to the commodities 6 or the transport packages 8 (S17).

The on-vehicle terminal 3 obtains unique ID stored in the IC tags 7 attached to the commodities 6 or the transport packages 8 to be unloaded from the transport means beforehand from the delivery plan information and the achievement information. Upon reading of the unique ID obtained beforehand, the on-vehicle terminal 3 displays a message in the display, and notifies that the commodities 6 or the transport packages 8 to which the IC tags 7 having the unique ID read therefrom are attached are commodities 6 or transport packages 8 to be unloaded from the transport means to the user.

This process may be executed when the commodities 6 or the transport packages 8 are collected at a shipping base.

Then, the specified commodities 6 or transport packages 8 are unloaded at a reception base. The retailer base terminal 9 reads the IC tags 7 attached to the unloaded commodities 6 or transport packages 8 via the antenna 95 (S18).

Upon reading of the IC tag 7 attached to the transport package 8, the on-vehicle terminal 3 transmits unique ID stored in the read IC tag 7 attached to the transport package 8 to the information management server 2. Based on the received unique ID of the transport package 8, the information management server 2 specifies unique ID of commodities 6 packed in the transport package 8 from the commodity tracking information DB 27 to transmit it to the on-vehicle terminal 3. Accordingly, by reading the IC tag attached to the transport package 8, the user can understand the commodities 6 packed in the transport package 8.

In this case, as in the case of the commodity shipping process, the retailer base terminal 9 can check whether there is an excess or a shortage of the commodities 6 or the transport packages 8 to be unloaded from the transport means by referring to the delivery plan information stored in the information management server 2 to compare the delivery plan information with a reading result of the IC tags 7.

Then, the retailer base terminal 9 transmits the time of reading the IC tags 7, a name of a base for reading the IC tags 7, and arrival information added to the reading result to the information management server 2 (S19).

Upon reception of the arrival information transmitted from the retailer base terminal 9, the information management server 2 stores the received information as reception achievement information in the commodity tracing information DB 27 (S20). The information management server 2 updates, among the records registered in the delivery base terminal 282 stored in the delivery plan DB 28, a status 2825 of a record corresponding to the received arrival information to “FINISHED.”

The maker base terminal 1, the on-vehicle terminal 3, and another retailer base terminal 9 transmit a request of referring to the reception achievement information to the information management server 2 to refer to the reception achievement information stored in the commodity tracing information DB 27 (S21). Accordingly, up to which of the bases the delivery vehicle has finished collection of commodities or what volume of commodities 6 or transport packages 8 has been loaded on the transport means can be understood.

The shipping schedule registration process executed by the information management server 2 will be described below in detail.

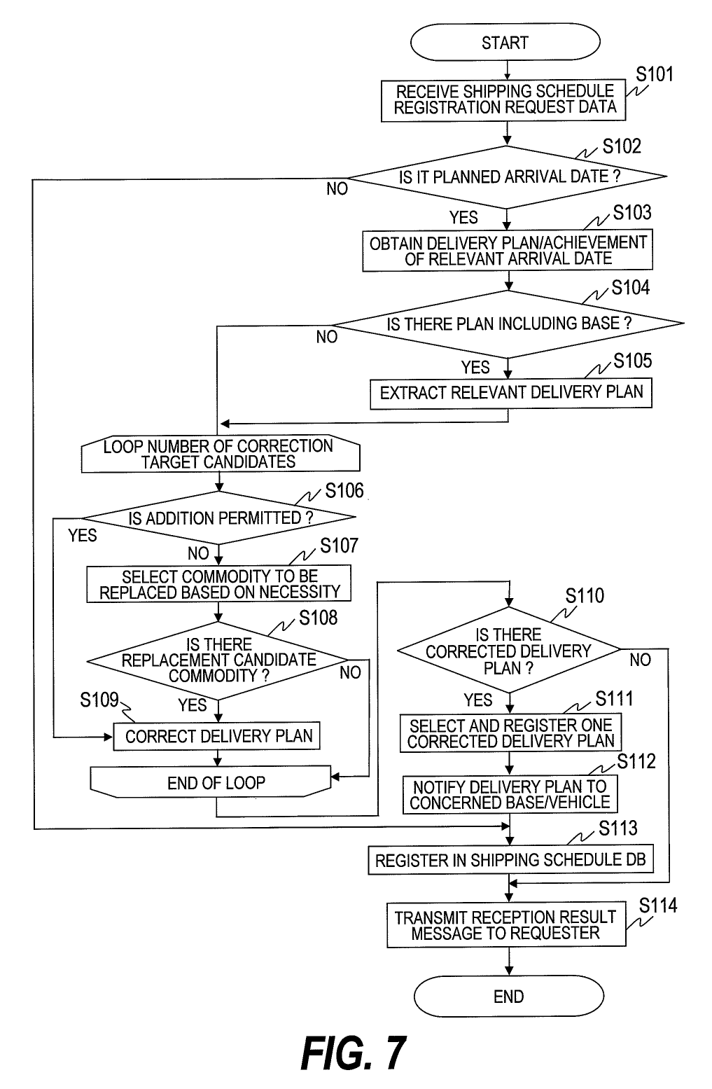

FIG. 7 is a flowchart of the shipping schedule registration process executed by the information management server 2 according to the first embodiment of this invention.

The flowchart shown in FIG. 7 specifically illustrates the detailed process of the steps S4 to S8 of the sequence diagram of FIG. 6.

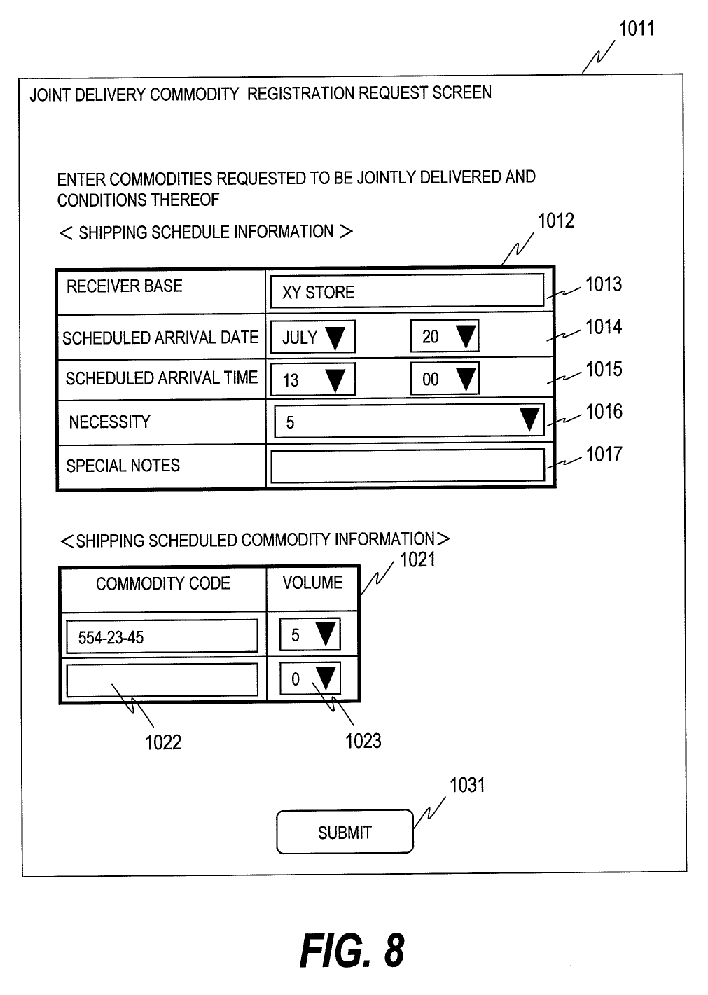

First, the information management server 2 receives shipping schedule registration request information transmitted from the maker base terminal 1 (S101). The shipping schedule registration request information is generated by entry of the shipping schedule registration request information executed by the user of the maker base terminal 1 via a shipping schedule registration request screen shown in FIG. 8. Referring to FIG. 8, the shipping schedule registration request screen 1011 will be described.

FIG. 8 illustrates a configuration of the shipping schedule registration request screen 1011 according to the first embodiment of this invention.

When shipping schedule registration request information is generated, the shipping schedule registration request screen 1011 is displayed in the display of the maker base terminal 1.

The shipping schedule registration request screen 1011 includes a shipping schedule information input section 1012, a shipping scheduled commodity information input section 1021, and a “submit” button 1031.

The shipping schedule information input section 1012 includes a receiver base input section 1013, a scheduled arrival date input section 1014, a scheduled arrival time input section 1015, a necessity input section 1016, and a special note input section 1017.

In the receiver base input section 1013, a name of a commodity receiver base is entered. The name of the commodity receiver base entered in the receiver base input section 1013 is registered in the receiver name 1612 of the shipping schedule information table 261.

In the scheduled arrival date input section 1014, a scheduled commodity reception date is entered. In the scheduled arrival time input section 1015, a schedule commodity reception time is entered. The scheduled commodity arrival date and time entered in the scheduled arrival date input section 1014 and the scheduled arrival time input section 1015 are registered in the arrival date and time 2614 included in the shipping schedule information table 261.

In the necessity input section 1016, a numerical value indicating necessity of commodities to be shipped is entered. The numerical value indicating the necessity of commodities to be shipped entered in the necessity input section 1016 is registered in the necessity 2615 included in the shipping schedule information table 261.

In the special note input section 1017, a special note of the commodities to be shipped is entered. The special note of the commodities to be shipped entered in the special note input 1017 is registered in the special note 2617 included in the shipping schedule table 261.

In the shipper name 2613 included in the shipping schedule table 261, based on a unique identifier of the maker base terminal 1 for transmitting the shipping schedule registration request information to the information management server 2, a name of the maker base terminal 1 is registered.

The necessity entered in the necessity input section 1016 is a numerical value indicating necessity or urgency of the commodities to be shipped. In the necessity input section 1016, integers of 1 to 10 are entered. As the numerical value entered in the necessity input section 1016 is higher, necessity or urgency of commodities to be shipped is higher.

The necessity entered in the necessity input section 1016 is decided by, for example, a retailer side based on an inventory status of commodities of the retailer side which orders commodities. In this case, the user of the maker base terminal 1 enters necessity to the necessity input section 1016 on behalf of the retailer side.

The necessity entered in the necessity input section 1016 may be decided by the maker side based on an inventory status of commodities at a distribution center of the maker side.

The necessity may be automatically decided based on a prior agreement between the maker and the retailer. For example, when there is description of “DEFECT REPLACEMENT” in the special note input section 1017, if there is an agreement that necessity is set to a maximum value 10 while others are set to minimum values 0, in the process of the step S101, the information management server 2 may automatically decide a numerical value of necessity.

It has been described that necessity is entered for each shipping schedule. However, necessity may be entered for each commodity to be shipped.

The shipping scheduled commodity information input section 1021 includes a commodity code input section 1022 and a volume input section 1023.

In the commodity code input section 1022, a commodity code of a commodity to be shipped is entered. The commodity code entered in the commodity code input section 1022 is registered in the commodity code 2622 included in the shipping scheduled commodity table 262.

In the volume input section 1023, a volume of commodities to be shipped is entered. The volume of commodities to be shipped entered in the volume input section 1023 is registered in the volume 2623 included in the shipping scheduled commodity table 262.

When all the input sections are entered and the “submit” button 1031 is operated, entered contents are transmitted as shipping schedule registration request information to the information management server 2.

Upon reception of the shipping schedule registration request information, the information management server 2 judges whether, among pieces of delivery plan information stored in the delivery plan DB 28, delivery plan information of the same scheduled arrival date as that included in the received shipping schedule registration request information is present (S102).

If it is judged that delivery plan information of the same scheduled arrival date as that included in the received shipping schedule registration request information is not present, as there is no delivery plan information to be corrected corresponding to the received shipping schedule registration request information, the process proceeds to a step S113.

On the other hand, if it is judged that delivery plan information of the same scheduled arrival date as that included in the received shipping schedule registration request information is present, as the delivery plan information is corrected to match the received shipping schedule registration request information, the process proceeds to a step S103.

In the step S103, the information management server 2 obtains the delivery plan information of the same scheduled arrival date as that included in the received shipping schedule registration request information (S103). When a plurality of pieces of delivery plan information of the same scheduled arrival date as that included in the received shipping schedule registration request information are present, all the pieces of delivery plan information are loaded to the memory of the processing unit 22.

When the scheduled arrival date included in the received shipping schedule registration request information is a delivery day, the information management unit 2 refers to the achievement information stored in the commodity tracing information DB 27 to obtain a name of a base which has not delivered commodities yet.

Then, the information management server 2 refers to the delivery plan base table 282 of the delivery plan information obtained in the step S103 to judge whether among the records registered in the delivery plan base table 282, a record having a name of a base registered in the base name 2822 and matched with a name of a shipper base or a name of a receiver base included in the delivery shipping schedule registration request information is present (S104).

If it is judged that among the records registered in the delivery plan base table 282, a record in which a name of a base registered in the base name 2822 matches a name of a shipper base or a receiver base included in the delivery shipping schedule registration request information is not present, the process proceeds to a step S106.

It is judged that among the records registered in the delivery plan base table 282, a record in which a name of a base registered in the base name 2822 matches a name of a shipper base or a receiver base included in the delivery shipping schedule registration request information is present, the information management server 2 extracts relevant delivery plan information (S105) to proceed to the step S106.

Specifically, the information management server 2 obtains, among the records registered in the delivery plan base table 282, a number registered in a delivery plan base number 2821 of a record in which a name of a base registered in the base name 2822 matches a name of a shipper base or a receiver base included in the delivery shipping schedule registration request information. The information management server 2 obtains a record associated with the obtained number registered in the delivery plan base number 2821, and registered in the delivery plan table 281. Then, the information management server 2 extracts a record associated with the obtained number registered in the delivery plan base number 2821, and registered in the delivery plan commodity table 283.

When the scheduled arrival date included in the received shipping schedule registration request information is a delivery day, the information management server 2 extracts, among the records registered in the delivery plan base table 282, a record yet to be delivered. Specifically, the information management server 2 extracts a record in which “NOT YET” is registered in the status 2825.

If it is judged in the step S104 that among the records registered in the delivery plan base table 282, a record in which a name of a base registered in the base name 2822 matches a name of a shipper base or a receiver base included in the delivery shipping schedule registration request information is present, the information management server 2 sets the delivery plan information obtained in the step S105 as delivery plan information of a correction target candidate.

If it is judged in the step S104 that among the records registered in the delivery plan base table 282, a record in which a name of a base registered in the base name 2822 matches a name of a shipper base or a receiver base included in the delivery shipping schedule registration request information is not present, the delivery plan information obtained in the step S103 is set as delivery plan information of a correction target candidate.

Then, the processes from steps S106 to S109 are carried out for the delivery plan information of all correction target candidates.

The information management server 2 obtains a capacity of commodities registered in the commodity master 25 based on commodity codes included in the shipping schedule registration request information. Then, the information management server 2 refers to the load efficiency 2814 of the record registered in the delivery plan table 281 corresponding to delivery plan information of a correction target to judge, based on the obtained capacity of commodities, whether commodities included in the shipping schedule registration request information can be added to the delivery vehicle (S106).

If it is judged that the commodities included in the shipping schedule registration request information can be added to the delivery vehicle, the process proceeds to a step S109.

On the other hand, if it is judged that the commodities included in the shipping schedule registration request information cannot be added, commodities to replace the commodities included in the shipping schedule registration request information are selected for the delivery vehicle (S107).

Specifically, the information management server 2 obtains, among the records registered in the shipping schedule table 261, a numerical value registered in the necessity 2615 of the record in which a number registered in the shipping schedule number 2611 matches a number registered in the shipping schedule number 2834 included in the record registered in the delivery plan commodity table 283 corresponding to the delivery plan information of the correction target.

Then, the information management server 2 compares the numerical value registered in the necessity included in the shipping schedule registration request information with the obtained numerical value registered in the necessity 2615. All records of numerical values registered in the necessity 2615 smaller than the numerical value registered in the necessity included in the shipping schedule registration request information are obtained as replacement candidate commodities.

A transport package 8 may be obtained as a replacement candidate commodity. In this case, the information management server 2 refers to the commodity tracing information table 271 to retrieve a number registered in the delivery plan number 2718 and matched with the number registered in the delivery plan number 2811 included in the record of the delivery plan table 281 corresponding to the delivery plan information of the correction target. Then, the information management server 2 retrieves packed shipping scheduled commodities based on an identifier registered in the relevant record package ID 2717. If commodities 6 linked to an IC tag 7 of the package 8 with a string are present, the commodities are set as replacement candidate commodities by a package unit. In this case, necessity 2615 of the shipping schedule information of the commodities 6 packed in the package 8 is obtained, and its maximum value is set as necessity of the package 8.

The information management server 2 obtains a commodity code registered in the commodity code 2832 of the record of the delivery plan commodity table 283 corresponding to the commodities obtained as the replacement candidate commodities. Then, the information management server 2 refers to the commodity master 25 to obtain a capacity of replacement target commodities.

The information management server 2 calculates load efficiency of the transport means from the capacity of the replacement target commodities. The information management server 2 also calculates load efficiency of the transport means from the capacity of the commodities included in the shipping schedule registration request information. The information management server 2 subtracts the calculated load efficiency of the replacement target commodities from the load efficiency 2814 of the record of the delivery plan table 281 corresponding to delivery plan information which becomes a correction candidate target. Then, the information management server 2 adds the subtracted value to the calculated load efficiency of the commodities included in the shipping schedule registration request information. If the added value is less than 100%, the information management server 2 obtains the commodities as replacement candidate commodities. If the added value is more than 100%, the information management server 2 selects a plurality of replacement candidate commodities so as to prevent the load efficiency 2814 from exceeding 100%, and obtains the plurality of selected replacement candidate commodities as one replacement candidate commodity.

If even one replacement candidate commodity obtained by the information management server 2 is present, the process proceeds to the step S109. On the other hand, when none of the replacement candidate commodities obtained by the information management server 2 is present, if the processes of the steps S106 to S109 are carried out for the delivery plan information of all the correction target candidates, the process proceeds to a step S110. In this case, however, if the processes of the steps S106 to S109 are not carried out for the delivery plan information of all the correction target candidates, one of the pieces of delivery plan information of the correction target candidates not subjected to the processes of the steps S106 to S109 is selected to return to the step S106 (S108). If even one of the replacement candidate commodities obtained by the information management server 2 is present, the information management server 2 transmits deliver plan information in which the commodities included in the shipping schedule registration request information have replaced the obtained replacement candidate commodities to the delivery plan making server 4. Upon reception of the delivery plan information transmitted from the information management server 2, the delivery plan making server 4 generates delivery plan information again based on the received delivery plan information. If a plurality of replacement candidate commodities are present, the delivery plan making server 4 generates delivery plan information for each replacement candidate commodity. Then, the delivery plan making server 4 transmits the generated delivery plan information to the information management server 2. The information management server 2 receives the delivery plan information transmitted from the delivery plan making server 4 (S109).

The information management server 2 judges whether corrected delivery plan information is present as a result of executing the processes of the steps S106 to S109 for all the pieces of delivery plan information of the correction target (S110).

If it is judged that no corrected delivery plan information is present, the process proceeds to step S114.

If it is judged that corrected delivery plan information is present, the information management server 2 selects one of the pieces of corrected delivery plan information.

Specifically, when a plurality of pieces of corrected delivery plan information are present, the information management server 2 refers to a selection reference registered in a setting file stored in the information management server 2 to select one from the plurality of pieces of delivery plan information.

As a selection reference, for example, there is a reference by which the information management server 2 selects delivery plan information in which the number of bases included in delivery plan information after correction and the number of bases included in delivery plan information before correction are smallest. As a selection reference, there is a reference by which the information management server 2 selects delivery plan information in which deviation between the arrival time of the transport means at a base and the departure time of the transport means from a base is smallest. As another selection reference, there is a reference by which the information management server 2 selects delivery plan information in which load efficiency of the delivery plan information after correction is closest to 100%.

Then, the information management server 2 stores the selected delivery plan information in the delivery plan DB 28 (S111).

Specifically, the information management server 2 obtains a number for uniquely identifying the selected delivery plan information to register in the delivery plan number 2811. The information management server 2 registers the obtained number in the correction plan number 2817 included in the record of the delivery plan table 281 corresponding to the delivery plan information before correction to change the status 2816 included in the record to “CORRECT.” Then, the information management server 2 registers each item included in the delivery plan information after correction based on the received delivery plan information.

The information management server 2 notifies the correction of the delivery plan information to the base of the name registered in the base name 2822 included in the record of the delivery plan base table 282 corresponding to the corrected delivery plan information. The information management server 2 notifies the correction of the delivery plan information to the transport means identified by the number registered in the vehicle number 2813 included in the record of the delivery plan table 2811 corresponding to the corrected delivery plan information (S112).

Specifically, the information management server 2 may notify only the number registered in the delivery plan number 2811 of the corrected delivery plan information to each base and the transport means, or send electronic mail including a written file in which the corrected delivery plan information is written to each base and the transport means.

Then, the information management server 2 stores the shipping schedule registration request information received in the step S101 in the shipping schedule DB 26 (S113).

Specifically, if it is judged in the process of the step S102 that among the pieces of delivery plan information stored in the delivery plan DB 28, delivery plan information of the same scheduled arrival date as that included in the received shipping schedule registration request information is present, and delivery plan information corresponding to the shipping schedule registration request information is stored in the delivery plan DB in the processes of the steps S103 to S112, the information management server 2 registers the number registered in the delivery plan number 2811 of the delivery plan information in the delivery plan number 2616. The information management server 2 registers “YES” in the additional flag 2618.

If it is judged in the process of the step S102 that among the pieces of delivery plan information stored in the delivery plan DB 28, delivery plan information of the same scheduled arrival date as that included in the received shipping schedule registration request information is not present, and the processes of the steps S102 to S113 are subsequently executed, the information management server 2 registers “NO” in the additional flag 2618 without registering anything in the delivery plan information 2616.

Upon correction of the delivery plan information, the information management server 2 registers, among the records registered in the shipping schedule table 261, a delivery plan number 2616 of the corrected delivery plan information in a delivery plan number 2616 of a record matched with a number registered in the shipping schedule number included in the record of the delivery plan commodity table 283 corresponding to the corrected delivery plan information.

Then, the information management server 2 transmits a message indicating reception of the shipping schedule registration request to the maker base terminal 1 which has transmitted the shipping schedule registration request information (S114). If the delivery plan information corresponding to the shipping schedule registration request information is stored in the delivery plan DB 28 in the step S111, the information management server 2 transmits the delivery plan information corresponding to the shipping schedule registration request information to the maker base terminal 1 which has transmitted the shipping schedule registration request information. If the delivery plan information cannot be corrected, in other words, if it is judged in the process of the step S110 that no corrected delivery plan information is present, the information management server 2 transmits a message indicating the impossibility of correcting the delivery plan information to the maker base terminal 1 which has transmitted the shipping schedule registration request information.

According to the embodiment, the information management server 2 registers the corrected delivery plan information in the delivery plan DB 28 in the process of the step S111, and then transmits the corrected delivery plan information to the maker base terminal 1, the retailer base terminal 9, and the on-vehicle terminal 3 in the process of the step S112.

However, if no message indicating disagreement with the corrected delivery plan information is received from the maker base terminal 1, the retailer base terminal 9, or the on-vehicle terminal 3 within a predetermined time after notification of the corrected delivery plan information to the maker base, the retailer base, and the transport means, the information management server 2 may store the corrected delivery plan information in the delivery plan DB 28. Upon reception of the message indicating disagreement with the corrected delivery plan information from the maker base terminal 1, the retailer base terminal 9, or the on-vehicle terminal 3 within the predetermined time after transmission of the corrected delivery plan information to the maker base terminal 1, the retailer base terminal 9, and the on-vehicle base terminal 3, the information management server 2 rejects the corrected delivery plan information to select another corrected delivery plan information not selected in the process of the step S111 again. The information management server 2 transmits the reselected delivery plan information to the maker base terminal 1, the retailer base terminal 9, and the on-vehicle terminal 3.

According to the embodiment, when commodities are shipped, IC tags 7 attached to the commodities are read, and a reading result of the IC tags 7 is stored in the commodity tracing information DB 27. However, when work (e.g., “MANUFACTURE,” “STOCK,” or “DELIVER”) before shipping of the commodities is carried out, IC tags 7 may be read, and a reading result of the IC tags 7 may be stored in the commodity tracing information DB 27. Then, the information management server 2 calculates necessity based on action information stored in the commodity tracing information DB 27.

For example, when commodities are manufactured, IC tags 7 are read, and a reading result and a commodity manufacturing date are stored in the commodity tracing information DB 27. Then, the information management server 2 refers to the action information stored in the commodity tracing information DB 27 to periodically update necessities of commodities so that necessities can be set higher in the order of old commodity manufacturing dates.

Thus, even in the case of commodities of the same commodity code, as commodities of low necessities, i.e., commodities of newer manufacturing dates, can be selected as replacement candidate commodities, the commodities can be shipped in the order of old manufacturing dates.

By executing the process of FIG. 7, the joint delivery information management system can generate shipping schedule plan information having enough time until a scheduled arrival date. The joint delivery information management system can add a new shipping schedule to the generated delivery plan information. Additionally, when the transport means makes the round of the bases, in other words, when the scheduled arrival date of the delivery plan information is a current day, the joint delivery information management system can add a new shipping schedule.

Even when commodities scheduled to be shipped cannot be loaded on the transport means, based on necessities of commodities loaded on the transport means and necessities of the commodities scheduled to be shipped, the joint delivery information management system can replace the commodities loaded on the transport means with the commodities scheduled to be shipped. Accordingly, the joint delivery information management system can deliver commodities to be urgently shipped and commodities of high urgency.

Referring to FIG. 9, a process executed by the information management server 2 upon reception of a request of inquiring about delivery plan information, a request of inquiring about arrival information, and a request of inquiring about shipping information will be described below.

FIG. 9 is a flowchart of a process of providing delivery information, arrival information, and shipping information according to the first embodiment of this invention.

First, the information management server 2 receives a request of inquiring about delivery information, a request of inquiring about arrival information, and a request of inquiring about shipping plan information from the maker base terminal 1, the on-vehicle terminal 3, and the retailer base terminal 9 (S201). Simultaneously, the information management server 2 receives conditions for specifying delivery information, arrival information, and shipping plan information such as a delivery plan number, a name of a shipper base, a name of a receiver base, and a scheduled arrival date entered from the maker base terminal 1, the on-vehicle terminal 3, and the retailer base terminal 9.

Then, the information management server 2 retrieves delivery plan information matched with the received conditions from the delivery plan DB 28 (S202).

If no delivery plan information matched with the received conditions is stored in the delivery plan DB 28, the process proceeds to step S207. On the other hand, if delivery plan information matched with the received conditions is stored in the delivery plan DB 27, the process proceeds to step S204 (S203).

In the process of the step S203, if the delivery plan information matched with the received conditions is stored in the delivery plan DB 28, the information management server 2 judges whether delivery plan information obtained by correcting the delivery plan information matched with the received conditions is present.

Specifically, the information management server 2 judges whether a delivery plan number has been registered in a corrected plan number 2818 of a record of the delivery plan information table 281 corresponding to the delivery plan information matched with the received conditions.

If judgment is made that delivery plan information obtained by correcting the delivery plan information matched with the received conditions is present, the information management server 2 obtains the delivery plan information matched with the received conditions as latest delivery plan information (S204).

Specifically, if it is judged that delivery plan information obtained by correcting the delivery plan information matched with the received conditions is present, the information management server 2 obtains delivery plan information identified by the delivery plan number registered in the corrected plan number 2818 of the record of the delivery plan information table 281 corresponding to the delivery plan information matched with the received conditions as latest delivery plan information.

In this case, the information management server 2 compares the obtained delivery plan information with the delivery plan information matched with the received conditions to calculate a difference in a name of a receiver base, commodities to be shipped, a scheduled arrival date, or the like.

Upon acquisition of the latest delivery plan information, the information management server 2 retrieves, among the records registered in the commodity tracing information table 271, a record in which a number registered in the delivery plan number 2718 matches the number registered in the delivery plan number 2811 of the delivery plan information obtained in the process of the step S204 (S205).

The information management server 2 obtains an identifier registered in commodity unique ID 2712 included in the retrieved record and information indicating a place registered in the place 2715. The information management server 2 refers to the commodity master 25 to obtain a commodity code and a commodity name corresponding to the obtained identifier.

The information management server 2 calculates differences between the base name 2822 included in the delivery plan base table 282 corresponding to the delivery plan information obtained in the process of the step S204 and the commodity code 2832 included in the delivery plan commodity table 283 corresponding to the delivery plan information obtained in the process of the step S204, and the information indicating the place registered in the place 2715 included in the retrieved record and the identifier registered in the commodity unique ID 2712 included in the retrieved record (S206).

Then, the information management server 2 generates screen information to be displayed in the displays of the maker base terminal 1, the on-vehicle terminal 3, and the retailer base terminal 9, and transmits the generated screen information to the maker base terminal 1, the on-vehicle terminal 3, and the retailer base terminal 9.

If it is judged in the process of the step S202 that no delivery plan information matched with the received conditions has been stored in the delivery plan DB 28, and the processes of the steps S203 to S206 are not executed, the information management server 2 generates screen information containing a message indicating absence of delivery plan information matched with the received conditions, and transmits the generated screen information to the maker base terminal 1, the on-vehicle terminal 3, and the retailer base terminal 9.

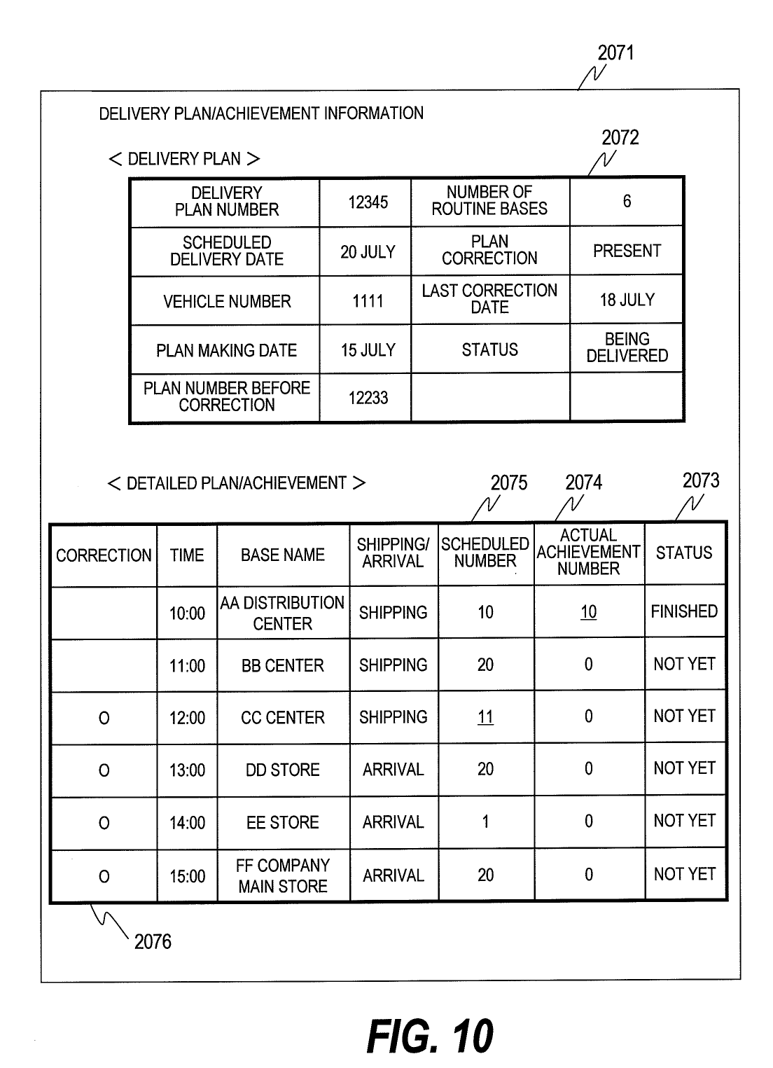

If it is judged in the process of the step S202 that delivery plan information matched with the received conditions has been stored in the delivery plan DB 28, and the processes of the steps S203 to S206 are executed, the information management server 2 generates screen information indicating contents of the delivery plan information and achievement information, and transmits the generated screen information to the maker base terminal 1, the on-vehicle terminal 3, and the retailer base terminal 9. Referring to FIG. 10, the screen information will be described below in detail.

FIG. 10 illustrates a configuration of a delivery plan information/achievement information screen 2071 according to the first embodiment of this invention.

The delivery plan information/achievement information screen 2071 displays the delivery plan information stored in the delivery plan DB 28.

The delivery plan information/achievement information screen 2071 includes a delivery plan display section 2072 and a detailed plan/achievement display section 2073.

The delivery plan display section 2072 displays contents of the delivery plan information table 281.

Specifically, the delivery plan display section 2072 includes a delivery plan number display section, a scheduled delivery date display section, a vehicle number display section, a plan making date display section, a plan number before-correction display section, a number-of-routine-bases display section, a plan correction display section, a last correction date display section, and a status display section.

In the delivery plan number display section, a number registered in the delivery plan number 2811 included in the delivery plan information table 281 is displayed. In the scheduled delivery date display section, a date registered in the scheduled delivery date 2812 included in the delivery plan information table 281 is displayed. In the vehicle number display section, a number registered in the vehicle number 2813 included in the delivery plan information table 281 is displayed.

In the plan making date display section, a date registered in the plan making/correction date 2815 included in the delivery plan information table 281 is displayed. In the plan number before correction display section, a number registered in the plan number before correction 2817 included in the delivery plan information table 281 is displayed. In the number-of-routine-bases display section, the number of names of bases registered in the base name 2822 included in the delivery plan base table 282 corresponding to the displayed delivery plan information is displayed.

In the plan correction display section, “PRESENT” is displayed if there is a number registered in the corrected plan number 2818 included in the delivery plan information table 281. On the other hand, in the plan correction display section, if there is no number registered in the corrected plan number 2818 included in the delivery plan information table 281, “NONE” is displayed.

In the last correction date display section, a date for correcting the delivery plan information is displayed. In the status display section, information registered in the status 2816 included in the delivery plan information table 281 is displayed.

The detailed plan/achievement display section 2073 includes a correction display section 2076, a time display section, a base name display section, and a shipping/arrival display section, a scheduled number display section 2075, an actual achievement number display section 2074, and a status display section 2073.

In the correction display section 2076, when delivery plan information to be displayed is corrected delivery plan information, a portion of a difference between the corrected delivery plan information and the before-correction delivery plan information is displayed by a circle mark.

In the time display section, the time of shipping commodities or the time of receiving commodities is displayed. Specifically, in the time display section, time registered in the time 2823 included in the delivery plan base table 282 is displayed.

In the base name display section, a name of a base for shipping commodities or a name of a base for receiving commodities is displayed. Specifically, in the base name display section, a name of a base registered in the base name 2822 included in the delivery plan base table 282 is displayed.

In the shipping/arrival display section, whether commodities are shipped or received is displayed. Specifically, in the shipping/arrival display section, information registered in the shipping/arrival 2824 included in the delivery plan base table 282 is displayed.

In the scheduled number display section 2075, the number of commodities to be shipped or received is displayed. Specifically, in the scheduled number display section 2075, a numerical value registered in the volume 2833 included in the delivery plan commodity table 283 is displayed.

In the actual achievement number display section 2074, the number of actually shipped or received commodities is displayed.

In the status display section 2073, a status of commodities to be shipped or received is displayed. Specifically, in the status display section 2073, information registered in the status 2825 included in the delivery plan base table 282 is displayed.

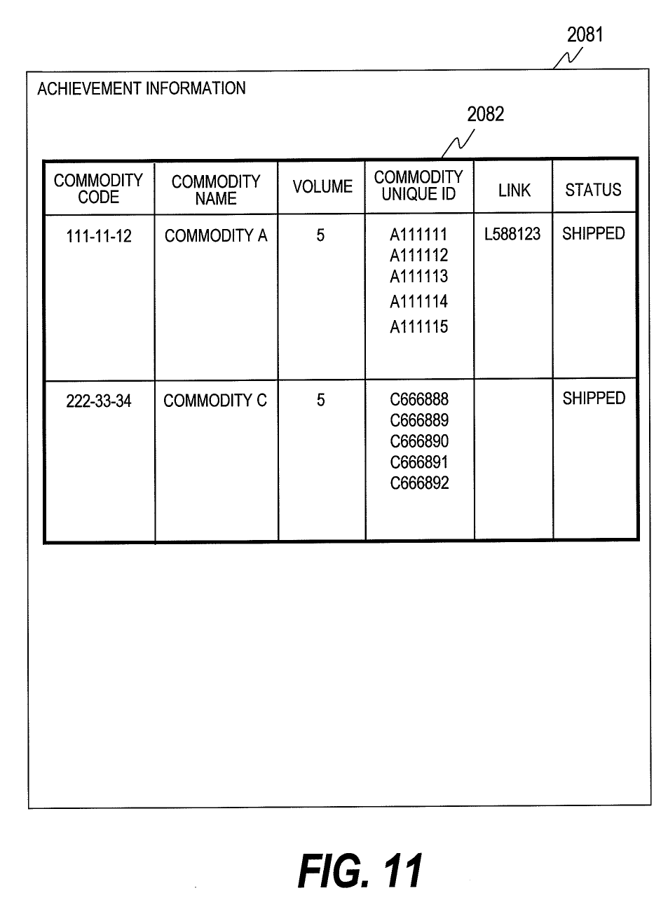

A place displayed in the actual achievement number display section 2074 is a link to an each-commodity achievement information screen 2081. When the user clicks the information displayed in the actual achievement number display section 2074, the each-commodity achievement information screen 2081 indicating the unique ID obtained in the process of the step S206 is displayed. Referring to FIG. 11, the each-commodity achievement information 2081 will be described below in detail.

FIG. 11 illustrates a configuration of the each-commodity achievement information screen 2081 according to the first embodiment of this invention.

The each-commodity achievement information screen 2081 includes a commodity display section 2082. The commodity display section 2082 includes a commodity code display section, a commodity name display section, a volume display section, a commodity unique ID display section, a linking display section, and a status display section.

In the commodity code display section, a commodity code of commodities actually shipped or received by the base of a name displayed in the base name display section of the record of the clicked actual achievement number display section 2074 is displayed.

In the commodity name display section, a name of the commodities actually shipped or received by the base of the name displayed in the base name display section of the record of the clicked achievement number display section 2074 is displayed.

In the volume display section, a volume of the commodities actually shipped or received by the base of the name displayed in the base name display section of the record of the clicked actual achievement number display section 2074 is displayed.

In the commodity unique ID display section, unique ID stored in an IC tag 7 attached to the commodities actually shipped or received by the base of the name displayed in the base name display section of the record of the clicked actual achievement number display section 2074 is displayed.

In the linking display section, when the commodities actually shipped or received by the base of the name displayed in the base name display section of the record of the clicked actual achievement number display section 2074 are packed in a transport package 8, unique ID stored in an IC tag 7 attached to the transport package 8 is displayed.

In the status display section, a status of the commodities actually shipped or received by the base of the name displayed in the base name display section of the record of the clicked actual achievement number display section 2074 is displayed.

Accordingly, a breakdown of the clicked actual achievement number display section 2074 can be displayed by a commodity unit.

If the commodities are packed in the transport package 8 before shipping as in the case of the processes of the steps S11 and S12 shown in FIG. 6, a place displayed in the scheduled number display section 2075 is a link to the each-commodity achievement information screen 2081.

Upon clicking of the link displayed in the scheduled number display section 2075, the each-commodity achievement information screen 2081 is displayed, and unique ID of the commodities packed in the package 8 is displayed.

Specifically, in the linking display section, the unique ID stored in the IC tag 7 attached to the transport package 8 is displayed. In the commodity unique ID display section of the record, the unique ID stored in the IC tag 7 attached to the commodities packed in the transport package 8 is displayed.

By carrying out the process of providing the delivery plan information, the arrival information, and the shipping information shown in FIG. 9, even if the delivery plan information is corrected, each terminal can refer to latest delivery plan information. Moreover, each terminal can refer to the achievement information indicating actual shipping or receiving of the commodities, so the each terminal can understand a progress of the transport means making the round of the delivery bases, and correct unfinished portions of the delivery plan information.

### Second Embodiment

According to a second embodiment of this invention, an information management server 2 manages correction history of delivery plan information for each base. The information management server 2 charges transport expenses to each base based on the correction history of the delivery plan information. The information management server 2 uses the correction history of the delivery plan information for selecting replacement candidate commodities.

Components similar to those of the first embodiment of this invention are denoted by similar reference numerals, and description thereof will be omitted.

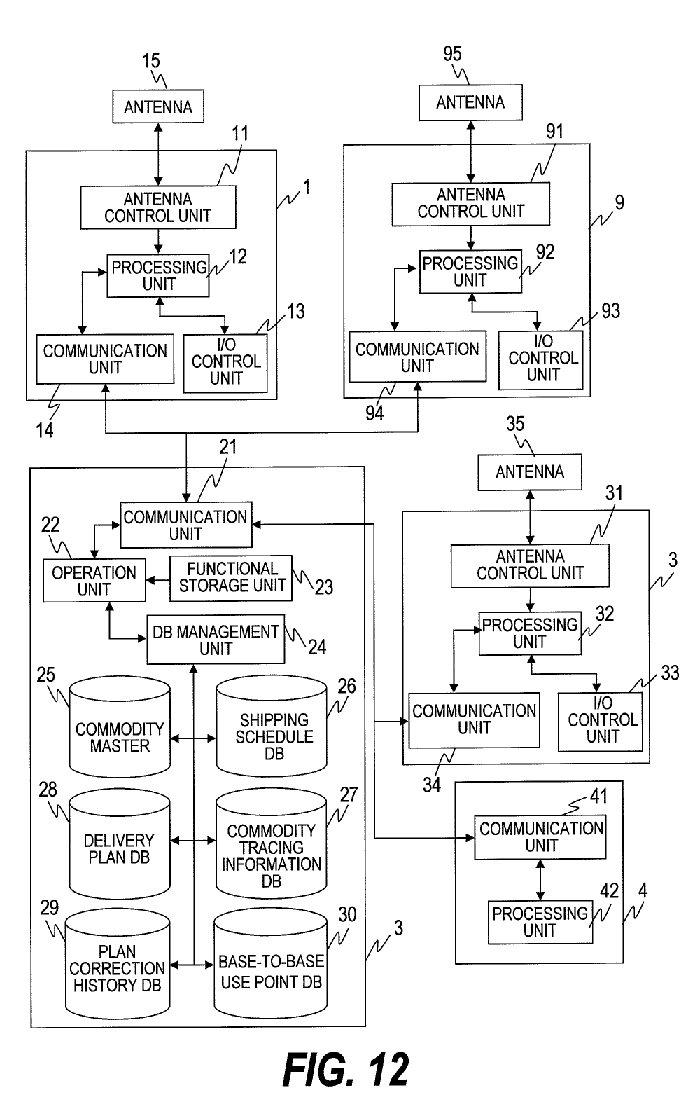

FIG. 12 is a block diagram of each computer installed in a joint delivery information management system according to the second embodiment of this invention.

The information management server 2 of the second embodiment of this invention includes a plan correction history database (DB) 29 and an each-base use point database (DB) 30.

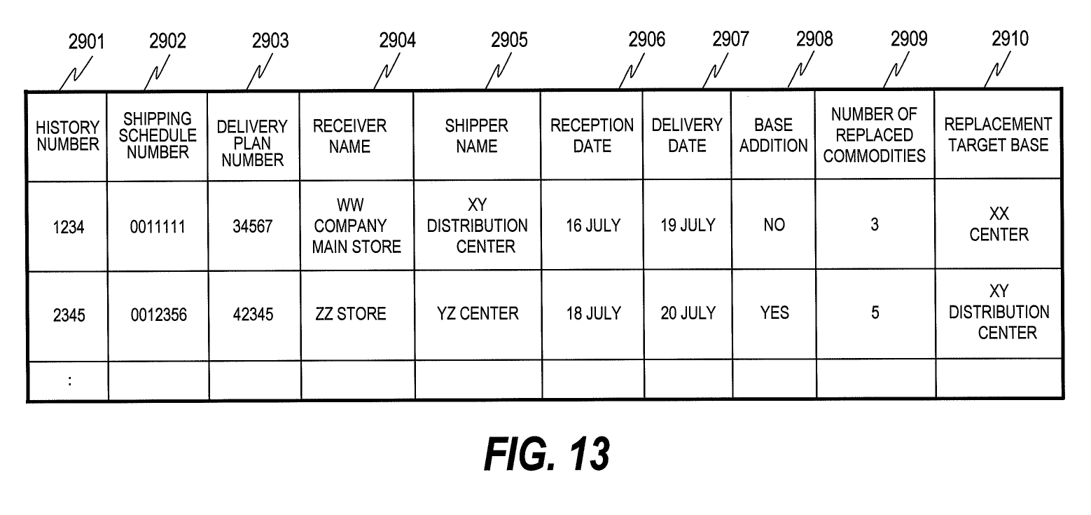

The plan correction history DB 29 stores shipping schedule information which has necessitated correction of delivery plan information, and commodities replaced by correcting the delivery plan information. Referring to FIG. 13, the plan correction history DB 29 will be described below in detail.

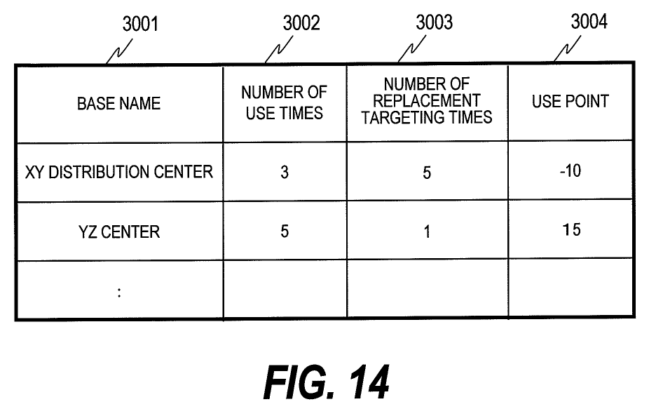

The each-base use point DB 30 stores use points for each base. Referring to FIG. 14, the each-base use point DB 30 will be described below in detail.

FIG. 13 illustrates a configuration of a plan correction history table 290 stored in the plan correction history DB 29 according to the second embodiment of this invention.

A record registered in the plan correction history table 290 indicates correction history of delivery plan information.

The plan correction history table 290 includes a history number 2901, a shipping schedule number 2902, a delivery plan number 2903, a receiver name 2904, a shipper name 2905, a reception date 2906, a delivery date 2907, a base addition 2908, a number of replaced commodities 2909, and a replacement target base 2910.

In the history number 2901, a number for uniquely identifying the correction history of the delivery plan information is registered. In the shipping schedule number 2902 stored in a shipping schedule DB 26, among records registered in a shipping schedule information table 261, a number registered in a shipping schedule number 2611 included in a record indicating shipping schedule information which necessitates correction of delivery plan information is registered. In the delivery plan number 2903, a number for uniquely identifying corrected delivery plan information is registered. In the receiver name 2904, a name of a receiver base of commodities is registered. In the shipper name 2905, a name of a shipper base of commodities is registered.

In the reception date 2906, a date on which the information management server 2 receives a shipping schedule registration request is registered. In the delivery date 2907, a date of delivering commodities is registered.

In the base addition 2908, information indicating whether a base of delivery has been added by correcting the delivery plan information is registered. In the number of replacement commodities 2909, the number of commodities selected as replacement candidate commodities and replaced is registered. In the replacement target base 2910, a name of a base scheduled to ship commodities selected as replacement candidate commodities and replaced is registered.

In the process of the step S101 of FIG. 7, upon reception of the shipping schedule registration request information, the information management server 2 adds a record to the plan correction history table 290.

If it is judged in the process of the step S102 that no delivery plan information of the same scheduled arrival date as that included in the received shipping schedule registration request information is present, the delivery plan information is not corrected by the received shipping schedule registration request information, and thus the information management server 2 executes the process of the step S114, and then deletes the added record.

On the other hand, if it is judged in the process of the step S102 that delivery plan information of the same scheduled arrival date as that included in the received shipping schedule registration request information is present, the delivery plan information is corrected by the received shipping schedule registration request information, and thus the information management server 2 executes the process of the step S114, and then registers the added record in the plan correction history DB 29.

Specifically, the information management server 2 obtains a new number to be registered in the history number 2901, and registers the obtained number in the history number 2901.

In the shipping schedule number 2908, the number registered in the shipping schedule number 2611 included in the record registered in the shipping schedule information table 2901 in the process of the step S113 is registered. In the receiver name 2904, a name of a base registered in the receiver name 2612 included in the record registered in the shipping schedule information table 2901 in the process of the step S113 is registered. In the shipper name 2905, a name of a base registered in a shipper name 2613 included in the record registered in the shipping schedule information table 2901 in the process of the step S113 is registered. In the reception date 2906, a date registered in arrival date and time 2614 included in the record registered in the shipping schedule information table 2901 in the process of the step S113 is registered.

In the delivery date 2907, a date registered in a scheduled delivery date 2812 included in the record of the delivery plan information table 281 stored in the delivery plan DB 28 in the process of the step S111 is registered.

If it is judged in the step S104 that among the records registered in the delivery plan base table 282, a record in which a name of a base registered in the base name 2822 matches the name of the shipper base and the name of the receiver base contained in the delivery shipping schedule registration request information is present, correction of the delivery plan information causes no change in the number of bases of delivery, and thus “NO” is registered in the base addition 2908.

On the other hand, if it is judged in the process of the step S104 that among the records registered in the delivery plan base table 282, no record in which the name of the base registered in the base name 2822 matches the name of the base of the shipper base and the name of the receiver base contained in the delivery shipping schedule registration request information is present, correction of the delivery plan information increases the number of bases of delivery, and thus “YES” is registered in the base addition 2908.

In the number of replaced commodities 2909, the number of commodities selected as replacement target commodities in the step S107 is registered. When the commodities are replaced by a unit of a transport package 8, in the number of replaced commodities 2909, the number of commodities packed in the transport package 8 is registered. In the replacement target base 2910, a name of a base scheduled to ship the replacement target commodities is registered.

FIG. 14 illustrates a configuration of each-base use point information 300 stored in the each-base use point DB 30 according to the second embodiment of this invention.

The each-base use point information 300 includes a base name 3001, number of use times 3002, number of replacement targeting times 3003, and a use point 3004.

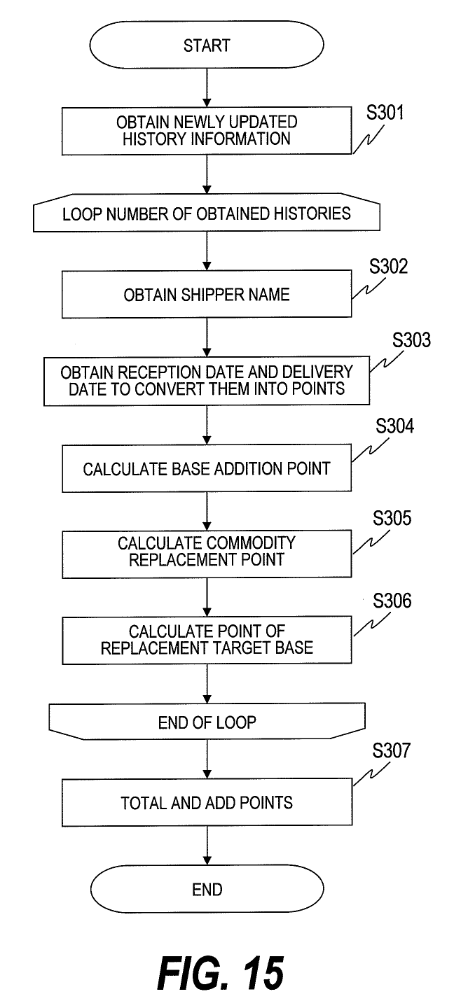

In the base name 3001, a name of a base is registered. In the number of use times 3002, the number of times of correcting delivery plan information based on a shipping schedule registration request transmitted from each base is registered. In the number of replacement targeting times 3003, the number of times of targeting commodities to be shipped for replacement is registered. In the use point 3004, a use point calculated by a process shown in FIG. 15 is registered.

A process of creating or changing the each-base use point table 300 by the information management server 2 will be described below. This process is periodically executed, for example, for each month or week.

FIG. 15 is a flowchart of the process of creating or changing the each-base use point table 300 by the information management server 2 according to the second embodiment of this invention.

First, the information management server 2 obtains, among the records registered in the plan correction history table 290 stored in the plan correction history DB 29, all records registered in the plan correction history table 290 after the last day of updating the each-base use point table 300 (S301).

Then, the information management server 2 selects one of the records obtained in the process of the step S301, and executes the process of steps S302 to S306 for the selected record. The process of the steps S302 to S306 are repeated until they are executed for all the records obtained in the process of the step S301.

The information management server 2 obtains a name to be registered in the shipper name 2905 included in the selected record (S302).

The information management server 2 obtains dates registered in the reception date 2906 and the delivery date 2907 included in the selected record.

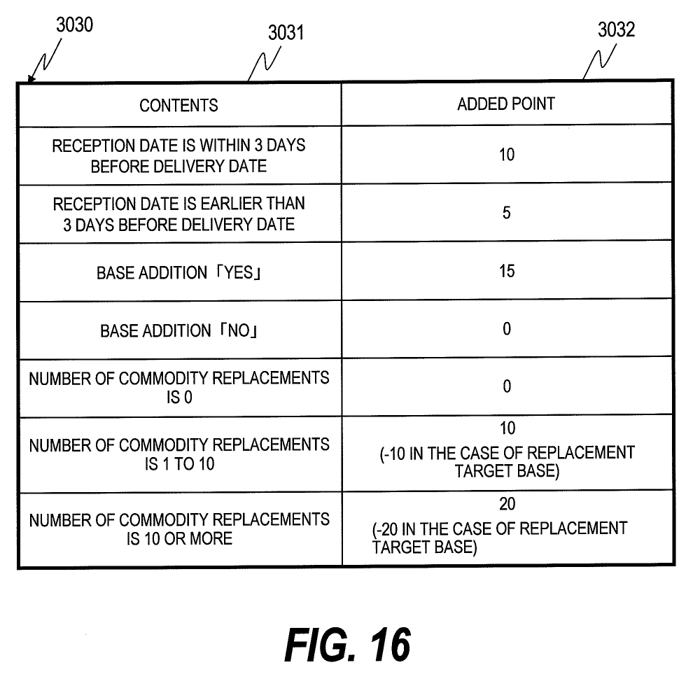

The information management server 2 calculates a period from the obtained date registered in the reception date 2906 to the obtained date registered in the delivery date 2907. Based on the calculated period and a point setting file 3030 shown in FIG. 16, the information management server 2 calculates a use point (S303).

Referring to FIG. 16, the point setting file 3030 will be described below.

FIG. 16 illustrates a configuration of the point setting file 3030 according to the second embodiment of this invention.

The point setting file 3030 is for converting contents of the plan correction history information 290 into a use point to be given to each base. The point setting file 3030 is stored in the information management server 2.

The point setting file 3030 includes contents 3031 and an added point 3032.

In the contents 3031, contents of the plan correction history information 290 which becomes a target of adding a use point is registered. In the added point 3032, a use point given to a base is registered for each content registered in the contents 3031.

The information management server 2 retrieves, among records registered in the point setting file 3030, a record in which the contents 3030 match contents of the plan correction history information 290. The information management server 2 obtains a use point registered in the added point 3032 included in the retrieved record.

Contents registered in the contents 3031 and the added point 3032 are determined based on a contract between bases.

In the process of the step S303, 10 use points are calculated if a reception date is within 3 days before a delivery date. In the process of the step S303, 5 use points are calculated if a reception date is earlier than 3 days before a delivery date.

The information management server 2 obtains information registered in a base addition 2908 included in the selected record.

Then, the information management server 2 calculates a use point based on the obtained information registered in the base addition 2908 and the point setting file 3030 (S304).

Specifically, if the information registered in the base addition 2908 is “YES,” 15 use points are calculated. On the other hand, if the information registered in the base addition 2908 is “NO,” 0 use point is calculated.

The information management server 2 obtains information registered in the number of replaced commodities 2909 included in the selected record.

The information management server 2 calculates use points based on the obtained information registered in the number of replaced commodities 2909 and the point setting file 3030 (S305).

The information management server 2 obtains a name registered in a replacement target base 2910 included in the selected record.

Based on the information registered in the number of replaced commodities 2909 and the point setting file 3030 obtained in the process of the step S305, the information management server 2 calculates a use point of a base of the obtained name registered in the replacement target base 2910 (S306).

If the information registered in the number of replaced commodities 2909 obtained in the process of the step S305 is “0,” the step S306 is not executed.

Upon execution of the process of the steps S302 to S306 for all the records obtained in the step S301, the information management server 2 calculates points obtained in the steps S303 to S306 to add the calculated points to the use point 3004.

The information management server 2 calculates, among the records obtained in the process of the step S301, the number of records having the same base names for each base. The information management server 2 adds the calculated number to the number of use times 3002 of each base.

The information management server 2 calculates information registered in the number of replaced commodities 2909 for each base. The information management server 2 adds the calculated number to the number of replacement targeting times of each base (S307).

The maker base terminal 1 and the retailer base terminal 9 can refer to the each-base use point table 300.

According to the embodiment of this invention, upon reception of the shipping schedule registration request information, the maker base terminal 1 adds a record to the plan correction history information table 290. However, when achievement information is registered in the commodity tracing information table 271, the maker base terminal 1 may add a record to the plan correction history information table 290.

According to the embodiment of this invention, the information management server 2 adds use points to the shipper base. However, the information management server 2 may add use points to the receiver base. The information management server 2 may add use points to the shipper base and the receiver base. In this case, in the replacement target base 2910 included in the plan correction history table 290, a name of the receiver base may be registered. Information on how use points are distributed between the shipper and receiver bases may be registered beforehand in the information management server 2, or included in the shipping schedule registration request information.

According to the embodiment of this invention, the joint delivery information management system can charge transport costs to each base based on use points. When selecting replacement candidate commodities, the joint delivery information management system can preferentially select commodities of a base having many use points.

Thus, the delivery plan information is corrected, without being frequently corrected, only when correction is truly necessary.

The preferred embodiments of this invention have been described in detail. However, this invention is not limited thereto, and various changes can be made without departing from the spirit and scope of the invention.

For target commodities of the embodiments of this invention, any types of commodities such as clothes, foods, ornaments, convenience goods, household consumer goods, books, media (e.g., media recording music or movies), home electronic appliances, electronic devices, sporting goods, and outdoor goods can be applied. The transport means of the embodiments of this invention is a vehicle such as a truck. However, any types of transport means such as a freight train and a cargo plane can be used.

The embodiments of this invention have been described by way of example where commodities are delivered between companies. However, the embodiments of this invention can be applied to delivery of commodities targeting consumers such as home delivery services.

According to the embodiments, the IC tag attached to the commodities is an IC tag incorporating an IC chip for storing only unique ID in the memory. However, an IC tag for storing not only unique ID but also commodity codes in the memory and enabling direct reading of the commodity codes without using any commodity masters may be used.

While the present invention has been described in detail and pictorially in the accompanying drawings, the present invention is not limited to such detail but covers various obvious modifications and equivalent arrangements, which fall within the purview of the appended claims.

What is claimed is:

1. A computer system for a delivery system which controls transport means to make the round of bases, thereby delivering commodities to the bases, the computer system comprising:
a shipping base terminal installed in a base for shipping the commodities;
a reception base terminal installed in a base for receiving the commodities;
a transport terminal installed in the transport means; and
an information management computer for managing information regarding the commodities to be delivered,
wherein the computer system stores attribute information of the commodities to be delivered,
wherein the information management computer is configured to:
store delivery plan information including a plan of delivering the commodities to the reception bases by the transport means;
refer to the delivery plan information to judge whether the commodities requested to be delivered are permitted to be loaded on the transport means, upon reception, from the shipping base terminal, of shipping schedule information for requesting delivery of the commodities shipped from the shipping base;
refer to attribute information of the commodities requested to be delivered to select commodities to replace with the commodities requested to be delivered from the commodities planned to be delivered, upon judgment that the commodities requested to be delivered are inhibited to be loaded on the transport means;
correct the delivery plan information to replace the selected commodities with the commodities requested to be delivered; and
transmit the corrected delivery plan information to the transport terminal, the shipping base terminal, and the reception base terminal, and
wherein the transport terminal, the shipping base terminal, and the reception base terminal display the delivery plan information transmitted by the information management computer.

2. The computer system according to claim 1,
wherein the attribute information of the commodities to be delivered includes a priority representing at least one of necessity and urgency of the commodities to be delivered, and
wherein the information management computer is further configured to:
refer to a priority of the commodities requested to be delivered and a priority of the commodities planned to be delivered;
select, from the commodities planned to be delivered, commodities having a priority lower than the priority of the commodities requested to be delivered and planned to be delivered as commodities to replace with the commodities requested to be delivered; and
correct the delivery plan information to replace the selected commodities with the commodities requested to be delivered.

3. The computer system according to claim 1,
wherein a tag holding identification information for uniquely identifying the commodities are attached to each of the commodities to be delivered,
wherein the shipping base terminal and the reception base terminal each comprises a reading unit for reading the identification information stored in the tags,
wherein the shipping base terminal and the reception base terminal read the identification information held in the tags attached to the commodities to be delivered, and transmit the read identification information to the information management computer, and
wherein the information management computer is further configured to:
store a received identification information upon reception of the read identification information;
specify a plan yet to be delivered among plans included in the delivery plan information based on the stored identification information; and
correct the specified plan.

4. The computer system according to claim 1,
wherein the computer system stores, when the commodities to be delivered are packed in transport packages, attribute information of the transport packages for packing the commodities to be delivered, and
wherein the information management computer is further configured to:
refer to the attribute information of the transport packages for packing the commodities planned to be delivered and the attribute information of the commodities requested to be delivered select, among the transport packages for packing the commodities planned to be delivered, a transport package to replace with the commodities requested to be delivered; and
correct the delivery plan information to replace the selected transport package with the commodities requested to be delivered.

5. The computer system according to claim 1, wherein the information management computer is further configured to:
store history of correcting the delivery plan information for each base upon correction of the delivery plan information;
calculate the number of correcting times of correcting the delivery plan information and the number of selecting times of selecting commodities to replace with the commodities requested to be delivered for each base, based on the stored history of correcting the delivery plan information;
calculate a first value by adding a preset numerical value added each time the delivery plan information is corrected to the number of correcting times;
calculate a second value based on the preset numerical value corresponding to the number of selecting times; and
calculate points for each base by adding together the calculated first value and the calculated second value.

6. An information management method executed by a computer system for a delivery system which controls transport means to make the round of bases, thereby delivering commodities to the bases,
the computer system having a shipping base terminal installed in a base for shipping the commodities, a reception base terminal installed in a base for receiving the commodities, a transport terminal installed in the transport means, and an information management computer for managing information regarding the commodities to be delivered,
the computer system storing attribute information of the commodities to be delivered,
the information management method comprising the steps of:
storing, by the information management computer, delivery plan information including a plan of delivering the commodities to the bases by the transport means;
referring, by the information management computer, to the delivery plan information to judge whether the commodities requested to be delivered are permitted to be loaded on the transport means, upon reception, from the shipping base terminal, of shipping schedule information for requesting delivery of the commodities shipped from the base;
referring, by the information management computer, to attribute information of the commodities requested to be delivered to select commodities to replace with the commodities requested to be delivered from the commodities planned to be delivered, upon judgment that the commodities requested to be delivered are inhibited to be loaded on the transport means;
correcting, by the information management computer, the delivery plan information to replace the selected commodities with the commodities requested to be delivered;
transmitting, by the information management computer, the corrected delivery plan information to the transport terminal, the shipping base terminal, and the reception base terminal; and
displaying, by the transport terminal, the shipping base terminal, and the reception base terminal, the transmitted delivery plan information.

7. The information management method according to claim 6,
wherein the attribute information of the commodities to be delivered includes a priority representing at least one of necessity and urgency of the commodities to be delivered, and
wherein the information management method further comprises the steps of:
referring to a priority of the commodities requested to be delivered and a priority of the commodities planned to be delivered;
selecting, from the commodities planned to be delivered, commodities having a priority lower than the priority of the commodities requested to be delivered and planned to be delivered as commodities to replace with the commodities requested to be delivered; and
correcting the delivery plan information to replace the selected commodities with the commodities requested to be delivered.

8. The information management method according to claim 6,
wherein a tag holding identification information for uniquely identifying the commodities are attached to each of the commodities to be delivered,
wherein the shipping base terminal and the reception base terminal each comprises a reading unit for reading the identification information stored in the tags,
wherein the shipping base terminal and the reception base terminal read the identification information held in the tags attached to the commodities to be delivered, and transmit the read identification information to the information management computer, and
wherein the information management method further comprises the steps of:
storing the received identification information upon reception of the read identification information;
specifying a plan yet to be delivered among plans included in the delivery plan information based on the stored identification information; and
correcting the specified plan.

9. The information management method according to claim 6,
wherein the computer system stores, when the commodities to be delivered are packed in transport packages, attribute information of the transport packages for packing the commodities to be delivered, and
wherein the information management method further comprises:
referring to the attribute information of the transport packages for packing the commodities planned to be delivered and the attribute information of the commodities requested to be delivered selecting, among the transport packages for packing the commodities planned to be delivered, a transport package to replace with the commodities requested to be delivered; and
correcting the delivery plan information to replace the selected transport package with the commodities requested to be delivered.

10. The information management method according to claim 6, further comprising:
storing history of correcting the delivery plan information for each base upon correction of the delivery plan information;
calculating the number of correcting times of correcting the delivery plan information and the number of selecting times of selecting commodities to replace with the commodities requested to be delivered for each base, based on the stored history of correcting the delivery plan information;
calculating a first value by adding a preset numerical value added each time the delivery plan information is corrected to the number of correcting times;
calculating a second value based on the preset numerical value corresponding to the number of correcting times; and
calculating points for each base by adding together the calculated first value and the calculated second value.
